(19) United States
(12) Patent Application Publication
(10) Pub. No.: US 2006/0136515 A1
(43) Pub. Date: Jun. 22, 2006

(54) Content synthesis device, content synthesis method, contents synthesis program, computer readable recording medium containing the content synthesis program, data structure of content data, and computer readable recording medium containing the content data

(76) Inventors: Tetsuya Matsuyama, Ichikawa-shi (JP); Junko Mikata, Soraku-gun (JP); Hideki Nishimura, Soraku-gun (JP)

Correspondence Address: BIRCH STEWART KOLASCH & BIRCH, PO BOX 747, FALLS CHURCH, VA, 22040-0747, US

(21) Appl. No.: 10/542,902

(22) PCT Filed: Jan. 22, 2004
(86) PCT No.: PCT/JP04/00561

§ 371 Date: Jul. 21, 2005

(30) Foreign Application Priority Data
Jan. 23, 2003 (JP) 2003-014948

(51) Int. Cl. G06F 17/30

(52) U.S. Cl. 707/204

(57) ABSTRACT

A contents synthesizing apparatus includes an input receiving portion receiving an input of first contents data including a synthesizing script describing synthesis of contents data and an input of second contents data, and a synthesis processing portion synthesizing the input first contents data with the input second contents data, based on the synthesizing script included in said input first contents data. Therefore, it becomes unnecessary to newly prepare a synthesizing script required for synthesizing contents data.

### TECHNICAL FIELD

The present invention relates to contents synthesizing apparatus, contents synthesizing method, contents synthesizing program, computer readable recording medium recording contents synthesizing program, data structure of contents data, and computer readable recording medium recording contents data. More specifically, the present invention relates to contents synthesizing apparatus, contents synthesizing method, contents synthesizing program, computer readable recording medium recording contents synthesizing program, data structure of contents data, and computer readable recording medium recording contents data that are suitable for synthesizing contents data.

### BACKGROUND ART

Recently, along with the wide spread use of the Internet, sales and distribution of digitized contents such as images and motion pictures are much increasing. When such digital contents are to be formed from scratch, in most cases, a dedicated authoring tool is used. Use of a dedicated authoring tool, however, often requires high skill, and therefore, it is not easily handled by a general user. In order to solve such a problem, a method has been known in which figures, objects and backgrounds for the contents are saved beforehand as components, and the components are combined to form new contents.

In the foregoing, conventional art related to the present invention has been described based on general technical information known to the applicant. To the best of applicant's memory, the applicant does not have any information to be disclosed as prior art, before the filing of this application.

The conventional method of synthesizing contents data, however, has the following problems. First, it is impossible for a creator of the contents data to define the synthesizing process. By way of example, a setting that allows combination of certain contents with specific contents only is not possible. Therefore, a creator of the contents cannot define the manner of synthesis.

Second, when the contents data are synthesized, a synthesizing script is necessary. It is difficult, however, for a general user to prepare the synthesizing script. Therefore, a general user must search for a synthesizing script matching the contents data to be synthesized.

### DISCLOSURE OF THE INVENTION

An object of the present invention is to provide contents synthesizing apparatus, contents synthesizing method, contents synthesizing program, computer readable recording medium recording contents synthesizing program, data structure of contents data, and computer readable recording medium recording contents data that allow control of the synthesizing process from the side of the contents data.

Another object of the present invention is to provide contents synthesizing apparatus, contents synthesizing method, contents synthesizing program, computer readable recording medium recording contents synthesizing program, data structure of contents data, and computer readable recording medium recording contents data that do not require preparation of new synthesizing script that is necessary for synthesizing the contents data.

In order to attain the above described objects, according to one aspect, the present invention provides a contents synthesizing apparatus, including: an input receiving portion receiving an input of first contents data including a synthesizing script describing synthesis of contents data and an input of second contents data; and a synthesis processing portion synthesizing the input first contents data with the input second contents data, based on the synthesizing script included in the input first contents data.

According to the present invention, the contents synthesizing apparatus receives inputs of the first contents data including a synthesizing script describing synthesis of contents data and the second contents data, and based on the synthesizing script included in the input first contents data, the input first contents data is synthesized with the input second contents data. Therefore, the synthesizing process is controlled by the synthesizing script included in the first contents data. Further, as the synthesizing script is included in the first contents data, it is unnecessary to newly prepare the synthesizing script when the first contents data is to be synthesized with the second contents data. As a result, a contents synthesizing apparatus can be provided that enables control of the synthesizing process from the side of the contents data and eliminates the necessity of newly preparing the synthesizing script required for synthesizing contents data.

Preferably, the apparatus further includes an attribute determining portion determining an attribute of the second contents data; wherein the synthesizing script includes scripts corresponding to a plurality of attributes of the contents data respectively; and the synthesis processing portion synthesizes the input first contents data with the input second contents data, based on the script corresponding to the determined attribute.

According to the present invention, the attribute of the second contents data is determined by the contents synthesizing apparatus, and based on the script corresponding to the determined attribute included in the synthesizing script included in the first contents data, the first contents data is synthesized with the second contents data. Therefore, the synthesizing process is controlled by the script corresponding to the attribute of the second contents data. As a result, the synthesizing process can be controlled from the side of the contents data, and the synthesizing process appropriate for the attribute of contents data becomes possible.

Preferably, the apparatus further includes a time obtaining portion for obtaining current time; wherein the synthesizing script includes scripts corresponding to time of synthesis by the synthesis processing portion; and the synthesis processing portion synthesizes the input first contents data with the input second contents data, based on the script corresponding to the obtained current time.

According to the present invention, the contents synthesizing apparatus obtains the current time, and based on the script corresponding to the obtained current time included in the synthesizing script of the first contents data, the first contents data is synthesized with the second contents data. Therefore, the synthesizing process is controlled by the script corresponding to the time of synthesis. As a result, the synthesizing process can be controlled from the side of the contents data, and the synthesizing process appropriate for the time of synthesizing the contents data becomes possible.

Preferably, the apparatus further includes a position obtaining portion obtaining a current position of the contents synthesizing apparatus; wherein the synthesizing script includes scripts corresponding to positions; and the synthesis processing portion synthesizes the input first contents data with the input second contents data, based on the script corresponding to the obtained current position.

According to the present invention, the contents synthesizing apparatus obtains the current position of the contents synthesizing apparatus, and based on the script corresponding to the obtained current position included in the synthesizing script of the first contents data, the first contents data is synthesized with the second contents data. Therefore, the synthesizing process is controlled by the script corresponding to the place of synthesis. As a result, the synthesizing process can be controlled from the side of the contents data, and the synthesizing process appropriate for the place of synthesizing the contents data becomes possible.

Preferably, the synthesizing script includes another synthesizing script; and the apparatus further includes a portion adding said another synthesizing script to the synthesized contents data.

According to the present invention, the contents synthesizing apparatus adds another synthesizing script included in the synthesizing script to the synthesized contents data. Therefore, the synthesizing process can be controlled from the side of the newly synthesized data.

Preferably, the synthesizing script includes location information indicating location of another synthesizing script; and the apparatus further includes: an obtaining portion obtaining another synthesizing script indicated by the location information; and an adding portion adding the obtained another synthesizing script to the synthesized contents data.

According to the present invention, the contents synthesizing apparatus obtains another synthesizing script indicated by the location information included in the synthesizing script representing the location of the said another synthesizing script, and the obtained another synthesizing script is added to the synthesized contents data. Therefore, the synthesizing process can be controlled from the side of the newly synthesized contents data.

Preferably, the first contents data and the second contents data include key frames defining frames of animation data; and the synthesizing script includes a script describing that data included in a key frame included in the second contents data should be inserted to a prescribed key frame of the first contents data.

According to the present invention, by the contents synthesizing apparatus, based on the synthesizing script including a script describing that the data included in a key frame of the second contents data should be inserted to a prescribed key frame of the first contents data, the data included in the key frame included in the input second contents data is inserted to the prescribed key frame of the input first contents data. Therefore, by the synthesizing script included in the first contents data, the synthesizing process of inserting the data included in the second contents data into the first contents data can be controlled. As a result, the synthesizing process of inserting other contents data can be controlled from the side of the contents data.

Preferably, the first contents data and the second contents data include key frames defining frames of animation data; and the synthesizing script includes a script describing that a key frame included in the second contents data should be added to a prescribed portion of the first contents data.

According to the present invention, by the contents synthesizing apparatus, based on the synthesizing script including a script describing that a key frame included in the second contents data should be added to a prescribed position of the first contents data, the key frame included in the input second contents is added to a prescribed position of the first contents data including a key frame. Therefore, by the synthesizing script included in the first contents data, the synthesizing process of adding the second contents data to the first contents data can be controlled. As a result, the synthesizing process of adding other contents data can be controlled from the side of the contents data.

Preferably, the first contents data includes a key frame defining a frame of animation data; the second contents data is data that can be included in the key frame; and the synthesizing script includes a script describing that prescribed data included in the key frame of the first contents data should be changed to the second contents data.

According to the present invention, by the contents synthesizing apparatus, based on the synthesizing script including a script describing that prescribed data included in a key frame of the first contents data should be changed to the second contents data, the prescribed data included in the key frame of the input first contents data is changed to the input second contents data. Therefore, by the synthesizing script included in the first contents data, the synthesizing process of changing the prescribed data included in the first contents data to the second contents data can be controlled. As a result, the synthesizing process of changing to other contents data can be controlled from the side of the contents data.

Preferably, the synthesizing script includes a script describing that a prescribed portion of the first contents data should be deleted.

According to the present invention, by the contents synthesizing apparatus, based on the synthesizing script including a script describing that a prescribed portion of the first contents data should be deleted, the prescribed portion of the input first contents data is deleted. Therefore, by the synthesizing script included in the first contents data, the synthesizing process of deleting the prescribed portion included in the first contents data can be controlled. As a result, the synthesizing process of deleting a prescribed portion of the contents data can be controlled from the side of the contents data.

According to another aspect, the present invention provides a contents synthesizing apparatus, including: an input receiving portion receiving an input of first contents data including location information indicating location of a synthesizing script describing synthesis of contents data and an input of second contents data; obtaining portion obtaining a synthesizing script indicated by the location information included in the input first contents data; and a synthesis processing portion synthesizing the input first contents data with the input second contents data, based on the obtained synthesizing script.

According to the present invention, the contents synthesizing apparatus receives inputs of the first contents data including location information indicating location of the synthesizing script describing synthesis of contents data and the second contents data; the synthesizing script indicated by the location information included in the input first contents data is obtained; and based on the obtained synthesizing script, the input first contents data is synthesized with the input second contents data. Therefore, by the synthesizing script included in the first contents data, the synthesizing process is controlled. Further, as the first contents data includes the location information of the synthesizing script, it is unnecessary to newly prepare the synthesizing script when the first contents data is to be synthesized with the second contents data. As a result, a contents synthesizing apparatus can be provided that enables control of the synthesizing process from the side of the contents data and eliminates the necessity of newly preparing the synthesizing script required for synthesizing contents data.

Preferably, the synthesizing script includes location information indicating location of another synthesizing script; and the obtaining portion further obtains another synthesizing script indicated by the location information; and the apparatus further includes an adding portion having the obtained another synthesizing script included in the synthesized contents data.

According to the present invention, the contents synthesizing apparatus obtains another synthesizing script indicated by the location information included in the synthesizing script indicating location of another synthesizing script, and the thus obtained another synthesizing script is added to the synthesized contents data. Therefore, the synthesizing process can be controlled from the side of the newly synthesized contents data.

According to a still further aspect, the present invention provides a contents synthesizing method of synthesizing contents by a computer, including the steps of: receiving an input of first contents data including a synthesizing script and an input of second contents data; and synthesizing the input first contents data with the input second contents data, based on the synthesizing script included in the input first contents data.

According to the present invention, a method of synthesizing contents that enables control of the synthesizing process from the side of the contents data and that eliminates the necessity of newly preparing the synthesizing script required for synthesizing contents data can be provided.

According to a still further aspect, the present invention provides a contents synthesizing method of synthesizing contents by a computer, including the steps of: receiving an input of first contents data including location information indicating location of a synthesizing script and an input of second contents data; obtaining the synthesizing script indicated by the location information included in the input first contents data; and synthesizing the input first contents data with the input second contents data, based on the obtained synthesizing script.

According to the present invention, a method of synthesizing contents that enables control of the synthesizing process from the side of the contents data and that eliminates the necessity of newly preparing the synthesizing script required for synthesizing contents data can be provided.

According to a still further aspect, the present invention provides a contents synthesizing program, causing a computer to execute the steps of receiving an input of first contents data including a synthesizing script and an input of second contents data; and synthesizing the input first contents data with the input second contents data, based on the synthesizing script included in the input first contents data.

According to the present invention, a contents synthesizing program and a computer readable recording medium having the contents synthesizing program recorded thereon that enable control of the synthesizing process from the side of the contents data and that eliminate the necessity of newly preparing the synthesizing script required for synthesizing contents data can be provided.

According to a still further aspect, the present invention provides a contents synthesizing program, causing a computer to execute the steps of receiving an input of first contents data including location information indicating location of a synthesizing script and an input of second contents data; obtaining the synthesizing script indicated by the location information included in the input first contents data; and synthesizing the input first contents data with the input second contents data, based on the obtained synthesizing script.

According to the present invention, a contents synthesizing program and a computer readable recording medium having the contents synthesizing program recorded thereon that enable control of the synthesizing process from the side of the contents data and that eliminate the necessity of newly preparing the synthesizing script required for synthesizing contents data can be provided.

According to a still further aspect, a data structure of contents data includes contents data, and a synthesizing script used when a synthesizing process of synthesizing the contents data with another contents data is executed by a computer.

According to the present invention, by the synthesizing script included in the contents data, the synthesizing process of synthesizing contents data with other contents data can be executed by a computer. As a result, data structure of contents data and a computer readable recording medium having the contents data recorded thereon that enable control of the synthesizing process from the side of the contents data and that eliminate the necessity of newly preparing the synthesizing script required for synthesizing contents data can be provided.

Preferably, the contents data and another contents data include key frames defining frames of animation data; and the synthesizing script includes a script describing that a key frame included in the said another contents data should be added to a prescribed portion of the contents data.

According to the present invention, by the computer, based on the synthesizing script including a script describing that a key frame included in the said another contents data should be added to a prescribed position of the contents data, the key frame included in the input another contents data is added to a prescribed position of the input contents data. Therefore, by the synthesizing script included in the contents data, the synthesizing process of adding another contents data to the contents data can be controlled. As a result, the synthesizing process of adding another contents data can be controlled from the side of the contents data.

Preferably, the contents data includes a key frame defining a frame of animation data; and the said another contents data is data that can be included in the key frame; and the synthesizing script includes a script describing that prescribed data included in the key frame of the contents data should be changed to the said another contents data.

According to the present invention, by the computer, based on the synthesizing script including a script describing that prescribed data included in a key frame of the contents data should be changed to another contents data, the prescribed data included in the key frame of the input contents data is changed to the input another data. Therefore, by the synthesizing script included in the contents data, the synthesizing process of changing the prescribed data included in the contents data to another contents data can be controlled. As a result, the synthesizing process of changing to another contents data can be controlled from the side of the contents data.

Preferably, the synthesizing script includes a script describing that a prescribed portion of the contents data should be deleted.

According to the present invention, by the computer, based on the synthesizing script including a script describing that a prescribed portion of the contents data should be deleted, the prescribed portion of the input contents data is deleted. Therefore, by the synthesizing script included in the contents data, the synthesizing process of deleting the prescribed portion included in the contents data can be controlled. As a result, the synthesizing process of deleting a prescribed portion of the contents data can be controlled from the side of the contents data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing a schematic configuration of a contents synthesizing apparatus in accordance with a first embodiment.

FIG. 2 schematically shows functions of the contents synthesizing apparatus in accordance with the first embodiment.

FIG. 3 is a flowchart representing a flow of a contents synthesizing process executed by the contents synthesizing apparatus in accordance with the first embodiment.

FIGS. 4A and 4B show data structures of the contents data before synthesis, in the first example of synthesis in accordance with the first embodiment.

FIG. 5 shows data structure of the contents data after synthesis, in the first example of synthesis in accordance with the first embodiment.

FIGS. 6A, 6B, 6C and 6D illustrate animation displayed when the contents data synthesized in accordance with the first example of synthesis of the first embodiment are reproduced.

FIGS. 7A and 7B show data structures of the contents data before synthesis, in the second example of synthesis in accordance with the first embodiment.

FIG. 8 shows data structure of the contents data after synthesis, in the second example of synthesis in accordance with the first embodiment.

FIGS. 9A, 9B, 9C and 9D illustrate animation displayed when the contents data synthesized in accordance with the second example of synthesis of the first embodiment are reproduced.

FIGS. 10A and 10B show data structures of the contents data before synthesis, in the third example of synthesis in accordance with the first embodiment.

FIG. 11 shows data structure of the contents data after synthesis, in the third example of synthesis in accordance with the first embodiment.

FIGS. 12A and 12B show data structures of the contents data before synthesis, in the fourth example of synthesis in accordance with the first embodiment.

FIG. 13 shows data structure of the contents data after synthesis, in the fourth example of synthesis in accordance with the first embodiment.

FIG. 14 schematically shows functions of the contents synthesizing apparatus in accordance with a second embodiment.

FIG. 15 is a flowchart representing a flow of a contents synthesizing process executed by the contents synthesizing apparatus in accordance with the second embodiment.

FIG. 16 is a flowchart representing a flow of an attribute determining process executed by the contents synthesizing apparatus in accordance with the second embodiment.

FIGS. 17A, 17B and 17C show data structures of the contents data before synthesis, in the first example of synthesis in accordance with the second embodiment.

FIGS. 18A, 18B, 18C, 18D, 18E, and 18F illustrate animation displayed when the contents data synthesized in accordance with the first example of synthesis of the second embodiment are reproduced.

FIG. 19 schematically shows functions of the contents synthesizing apparatus in accordance with a third embodiment.

FIG. 20 is a flowchart representing a flow of a data synthesizing process executed by the contents synthesizing apparatus in accordance with the third embodiment.

FIGS. 21A and 21B show data structures of the contents data before synthesis, in the first example of synthesis in accordance with the third embodiment.

FIGS. 22A, 22B, 22C, 22D, 22E, and 22F illustrate animation displayed when the contents data synthesized in accordance with the first example of synthesis of the third embodiment are reproduced.

FIG. 23 schematically shows functions of the contents synthesizing apparatus in accordance with a fourth embodiment.

FIG. 24 is a flowchart representing a flow of a data synthesizing process executed by the contents synthesizing apparatus in accordance with the fourth embodiment.

FIGS. 25A and 25B show data structures of the contents data before synthesis, in the first example of synthesis in accordance with the fourth embodiment.

FIG. 26 is a flowchart representing a flow of a data synthesizing process executed by the contents synthesizing apparatus in accordance with the fifth embodiment.

FIGS. 27A and 27B show data structures of the contents data before synthesis, in the first example of synthesis in accordance with the fifth embodiment.

FIG. 28 shows data structure of the contents data after synthesis, in the first example of synthesis in accordance with the fifth embodiment.

FIGS. 29A and 29B show data structures of the contents data before synthesis, in the second example of synthesis in accordance with the fifth embodiment.

FIG. 30 shows data structure of the contents data after synthesis, in the second example of synthesis in accordance with the fifth embodiment.

FIGS. 31A and 31B show data structures of the contents data before synthesis, in the third example of synthesis in accordance with the fifth embodiment.

FIG. 32 shows data structure of the contents data after synthesis, in the third example of synthesis in accordance with the fifth embodiment.

FIG. 33 schematically shows functions of the contents synthesizing apparatus in accordance with a sixth embodiment.

FIG. 34 is a flowchart representing a flow of a data synthesizing process executed by the contents synthesizing apparatus in accordance with the sixth embodiment.

### BEST MODES FOR CARRYING OUT THE INVENTION

### First Embodiment

In the following, embodiments of the present invention will be described with reference to the figures. In the figures, the same reference characters denote the same or corresponding portions, and repetitive descriptions will not be given.

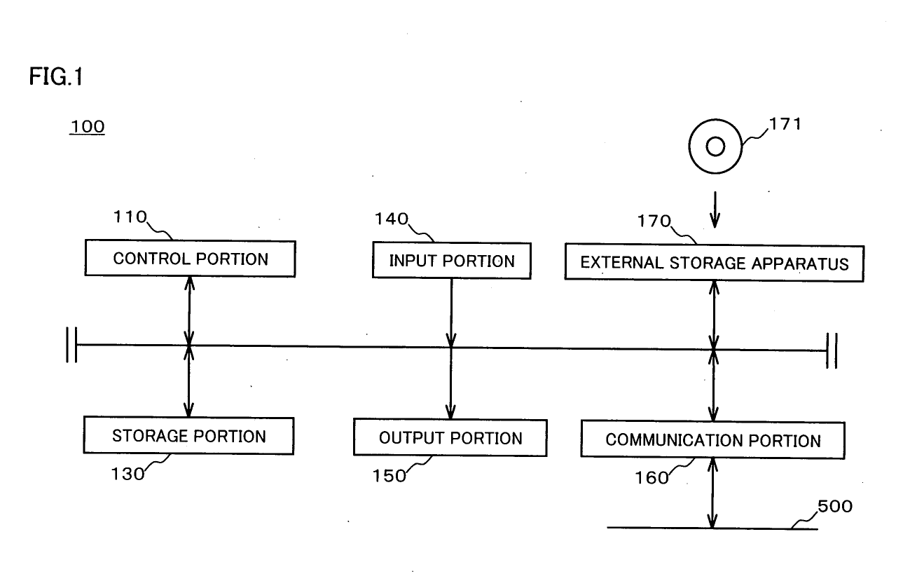

FIG. 1 is a block diagram schematically showing a configuration of a contents synthesizing apparatus 100 in accordance with the first embodiment. Referring to FIG. 1, contents synthesizing apparatus 100 can be implemented by a general-purpose computer such as a personal computer (hereinafter denoted by “PC (personal computer)”). Contents synthesizing apparatus 100 includes: a control portion 110 for overall control of contents synthesizing apparatus 100; a storage portion 130 for storing prescribed information; an input portion 140 for inputting prescribed information to contents synthesizing apparatus 100; an output portion 150 for outputting prescribed information from contents synthesizing apparatus 100; a communication portion 160 as an interface for connecting contents synthesizing apparatus 100 to a network 500; and an external storage apparatus 170 for inputting information recorded on a recording medium 171 or for recording necessary information on recording medium 171. Further, control portion 110, storage portion 130, input portion 140, output portion 150, communication portion 160, and external storage apparatus 170 are connected to each other through a bus.

Control portion 110 includes a CPU (Central Processing Unit) and auxiliary circuitry for the CPU, and it controls storage portion 130, input portion 140, output portion 150, and external storage apparatus 170, executes a prescribed process in accordance with a program stored in storage portion 130, processes data input from input portion 140, communication portion 160 and external storage apparatus 170, and outputs the processed data to output portion 150, communication portion 160 or to external storage apparatus 170.

Storage portion 130 includes an RAM (Random Access Memory) used as a work area necessary for control portion 110 to execute a program, and an ROM (Read Only Memory) for storing a program to be executed by control portion 110. Further, a magnetic disk storage apparatus such as a hard disk drive (hereinafter referred to as “HDD (Hard Disk Drive)” is used supplementary to the RAM.

Input portion 140 is an interface for inputting a signal from a keyboard, mouse or the like, which enables input of necessary information to contents synthesizing apparatus 100.

Output portion 150 is an interface for outputting a signal to a display such as a liquid crystal display or cathode ray tube (hereinafter referred to as a “CRT (Cathode Ray Tube)”, which enables output of necessary information from contents synthesizing apparatus 100.

Communication portion 160 is a communication interface for connecting contents synthesizing apparatus 100 to network 500. Contents synthesizing apparatus 100 transmits/receives necessary information to and from other PCs and the like, through communication portion 160.

External storage apparatus 170 reads program or data recorded on recording medium 171, and transmits the same to control portion 110. Further, external storage apparatus 170 writes necessary information to recording medium 171 in accordance with an instruction from control portion 110.

Computer readable recording medium 171 refers to a recording medium that fixedly carries a program, including a magnetic tape, a cassette tape, a magnetic disk such as a floppy (R) disk or hard disk, an optical disk such as a CD-ROM (Compact Disk Read Only Memory) or DVD (Digital Versatile Disk), a magneto-optical disk such as an MO (Magneto Optical disk) or an MD (Mini Disk), a memory card such as an IC card or an optical card, and a semiconductor memory such as a mask ROM, EPROM (Erasable Programmable Read Only Memory), EEPROM (Electrically Erasable and Programmable Read Only Memory) or a flash ROM. The recording medium may be one that carries a program in a flowing manner, for a program downloaded from network 500.

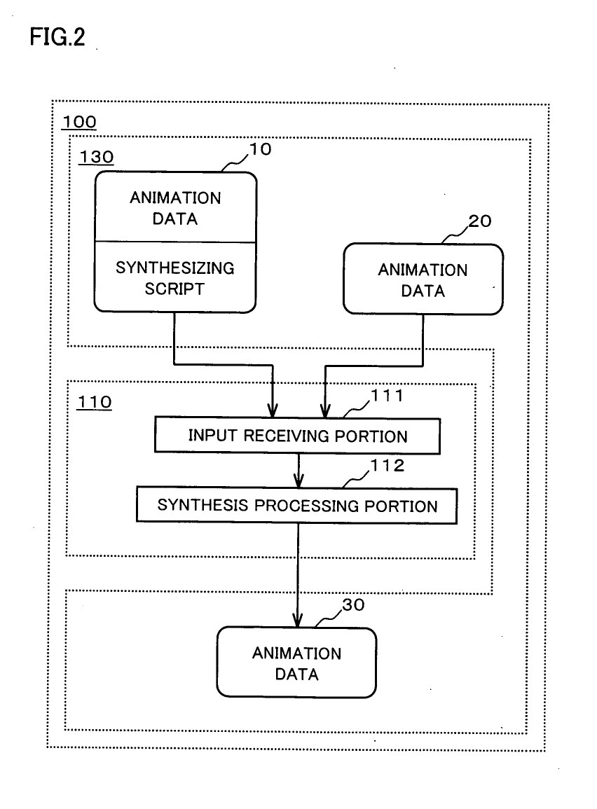

FIG. 2 schematically shows functions of contents synthesizing apparatus 100 in accordance with the first embodiment. Referring to FIG. 2, control portion 110 of contents synthesizing apparatus 100 includes an input receiving portion 111 and a synthesis processing portion 112. Storage portion 130 of contents synthesizing apparatus 100 stores a plurality of contents data. The contents data include contents data including animation data and a synthesizing script, and contents data including animation data.

The contents data may include motion picture data such as animation data, still image data, music data, figure data and the like, that can be output by a contents reproducing apparatus such as a computer. Here, an example will be described in which the contents data includes animation data, though it is not limiting. The animation data include a key frame that defines each frame of animation data.

The synthesizing script refers to information defining a procedure in a synthesizing process for synthesizing certain contents data with other contents data, and it is used when the synthesizing process is executed by contents synthesizing apparatus 100. The synthesizing script includes control contents and a parameter. The control contents represent the contents of synthesizing process. The parameter indicates the object of the synthesizing process. In the present embodiment, an example is discussed in which the contents data include animation data, and therefore, the synthesizing script is information defining the procedure in a synthesizing process in which animation data is synthesized with other animation data.

The contents data stored in storage portion 130 may be received in advance from other PC or the like through network 500 by communication portion 160 and stored in storage portion 130, or may be read from recording medium 171 by external storage apparatus 170 and stored in storage portion 130.

Input receiving portion 111 receives input of contents data 10 including the synthesizing script and contents data 20, stored in storage portion 130. The received contents data 10 and 20 are output to synthesis processing portion 112. Input receiving portion 111 may receive input of contents data 10 including the synthesizing script and the contents data 20 directly by communication portion 160 from other PC or the like through network 500, or may receive input of contents data 10 including the synthesizing script and the contents data 20 from recording medium 171 by external storage apparatus 170.

Synthesis processing portion 112 synthesizes the animation data included in contents data 10 with the animation data included in contents data 20, in accordance with the synthesizing script included in contents data 10. Then, synthesis processing portion 121 has the synthesized contents data 30 stored in storage portion 130. It is noted that synthesis processing portion 112 may transmit the synthesized contents data 30 directly to other PC or the like by communication portion 160 through network 500, or may have the synthesized contents data 30 recorded on recording medium 171 using external storage apparatus 170.

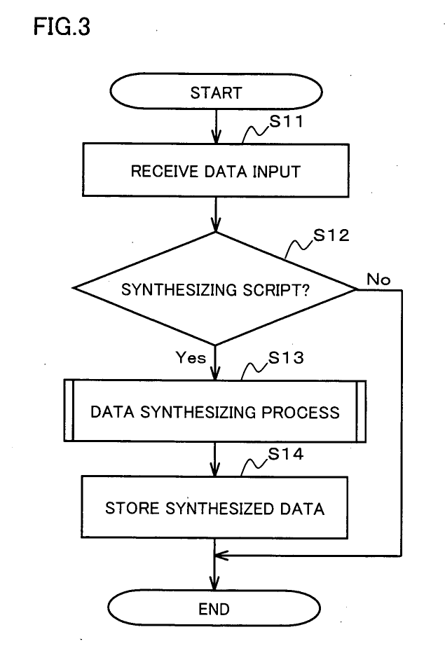

FIG. 3 is a flow chart representing the flow of contents synthesizing process executed by contents synthesizing apparatus 100 in accordance with the first embodiment. Referring to FIG. 3, first, in step S11, input receiving portion 111 receives input of contents data 10 including the synthesizing script and contents data 20, stored in storage portion 130.

Then, in step S12, synthesis processing portion 112 determines whether the contents data 10 or 20 input in step S11 includes the synthesizing script. When either of the contents data includes the synthesizing script (Yes in step S11), the flow proceeds to step S13. When neither of contents data include the synthesizing script (No in step S11), the contents synthesizing process ends. Here, contents data 10 input in step S11 includes the synthesizing script, and therefore, the flow proceeds to step S13. When both contents data include the synthesizing script, the contents synthesis process may be terminated, or, alternatively, the synthesizing script included in either one of the contents data may be used in the following steps.

In step S13, data synthesizing process is executed by synthesis processing portion 112. The data synthesizing process refers to a process of synthesizing the animation data included in contents data 10 with the animation data included in contents data 20 input in step S11, based on the synthesizing script included in contents data 10 input in step S11.

Finally, in step S14, the contents data 30 synthesized by synthesis processing portion 112 in step S13 is stored in storage portion 130, and the contents synthesizing process ends.

(First Example of Synthesis in Accordance with the First Embodiment)

Here, an example of synthesis will be described in which, based on the synthesizing script included in a contents data, data included in another contents data is inserted to the contents data.

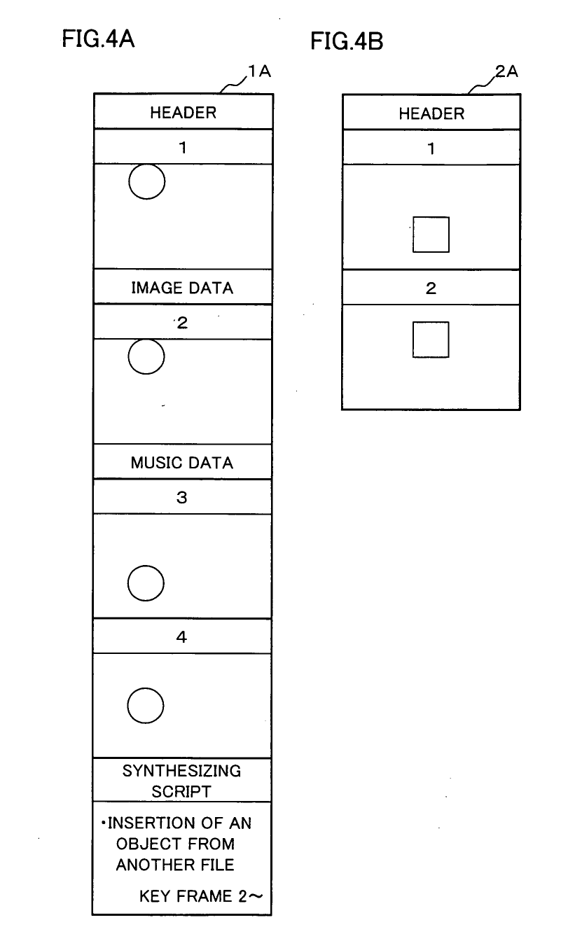

FIGS. 4A and 4B show data structures of the contents data before synthesis, in the first example of synthesis in accordance with the first embodiment. FIG. 4A shows data structure of contents data 1A including the synthesizing script. Referring to FIG. 4A, contents data 1A includes a header, key frames 1 to 4, and the synthesizing script.

The header includes data representing attributes of the animation data, such as display size, number of key frames and reproduction time interval of each key frame, of the animation data. The key frame refers to data that defines a frame of the animation data. From the reproduction time interval of each key frames, the time when each key frame is reproduced is determined. Then, in accordance with the frame rate indicating the number of frames that can be reproduced per one second by the reproducing apparatus reproducing the animation data, frames between the key frames are interpolated. Then, the key frames and the interpolated frames are successively reproduced, realizing the animation.

Key frame 1 includes object data and image data. The object data represents a figure, consisting of shape data representing the shape of the figure, and position data representing the position of the figure. Here, the object data represents that the figure has a circular shape and that the figure is positioned at an upper portion of the image plane, slightly left from the center. In the following, for easier visual understanding, the object data will be represented by an image of the figure defined by the object data displayed on the image plane. The image data refers to data of the image displayed on the background of the animation, such as a pattern, picture, or photograph image, encoded in a prescribed coding format. The image data is kept displayed until a key frame including different image data is reproduced.

Key frame 2 includes object data and music data. The object data represents the same figure as that represented by the object data included in key frame 1, and therefore, these object data are related to each other. Here, the object data represents that the figure is positioned at an upper portion of the image plane, slightly left from the center. The music data is to generate sound as the animation proceeds, representing music or sound effect encoded in a prescribed coding format allowing generation of sound by the computer. The music data continuously generates the same music until a key frame including different music data is reproduced.

Key frames 3 and 4 respectively include object data. These object data represent the same figure as that represented by the object data included in key frames 1 and 2, and therefore, these object data are related to each other. Specifically, the object data included in key frames 1 to 4 are related to each other among key frames. Therefore, when the animation data is reproduced, the figure represented by the object data is displayed as an animation of the figure, along with the progress of key frames. Such a method of animation is referred to as vector animation method.

Here, the object data included in key frame 3 represents that the figure is at a slightly lower portion from the center of the image plane, slightly left from the center. Further, the object data included in key frame 4 represents that the figure is slightly left from the center of the image plane. Specifically, when key frames 1 to 4 are reproduced, the circular figure first appears at an upper portion of the image plane, slightly left from the center, stays at the same position for a while, then moves downward to a portion slightly lower than the center, and again moves upward near to the center.

The synthesizing script included in contents data 1A includes, as control contents, “insertion of an object from another file”, and as a parameter, “key frame 2˜.” The control contents “insertion of an object from another file” indicates that the object data included in the animation data of another contents data 2A should be inserted to the target position designated by the parameter. The parameter “key frame 2˜” represents that the target position of synthesizing process indicated by the control contents is from key frame 2 of the animation data included in contents data 1A including the synthesizing script.

FIG. 4B represents data structure of contents data 2A. Referring to FIG. 4B, contents data 2A includes a header and key frame 1 data˜key frame 2.

Key frames 1 and 2 include object data. Here, the object data represents that the figure has a square shape and that the figure is positioned slightly lower than the center of the image plane. Further, the object data included in the key frame represents the same figure as that represented by the object data included in key frame 1, and that the figure is positioned slightly upper than the center of the image plane.

Contents synthesizing apparatus 100 receives inputs of contents data 1A and 2A, and whether contents data 1A or 2A includes a synthesizing script or not is determined. As contents data 1A includes the synthesizing script, the animation data included in contents data 1A is synthesized with animation data included in contents data 2A based on the synthesizing script, and contents data 3A, which will be described later, is stored.

The synthesizing script describes that to each key frame from key frame 2 of contents data 1A including the synthesizing script, the object data included in each key frame of contents data 2A is to be inserted.

Therefore, contents synthesizing apparatus 100 provides key frame 1 of contents data 1A as a new key frame 1.

Then, the object data included in key frame 1 of contents data 2A is inserted to key frame 2 of contents data 1A, to provide a new key frame 2.

Then, the object data included in key frame 2 of contents data 2A is inserted to key frame 3 of contents data 1A, to provide a new key frame 3.

Next, key frame 4 of contents data 1A is provided as a new key frame 4.

Finally, based on the new key frames 1 to 4, a header is generated, and contents data 3A including the header and the new key frames 1 to 4 is synthesized and stored.

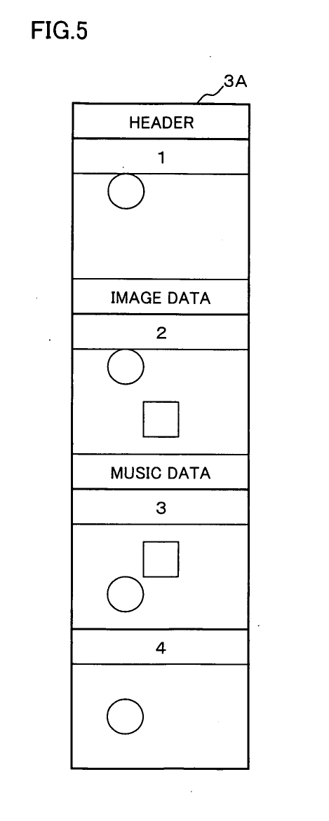

FIG. 5 shows a data structure of contents data 3A synthesized in accordance with the first example of synthesis of the first embodiment. Referring to FIG. 5, contents data 3A having contents data 1A and contents data 2A synthesized by contents synthesizing apparatus 100 consists of the header and key frames 1 to 4.

The header is generated based on the key frames 1 to 4 of synthesized contents data 3A and is included in contents data 3A.

Key frame 1 is the same as key frame 1 of contents data 1A described with reference to FIG. 4A.

Key frame 2 is the key frame 2 of contents data 1A, having the object data included in key frame 1 of contents data 2A described with reference to FIG. 4B inserted.

Key frame 3 is the key frame 3 of contents data 1A, having the object data included in key frame 2 of contents data 2A inserted.

Key frame 4 is the same as key frame 4 of contents data 1A.

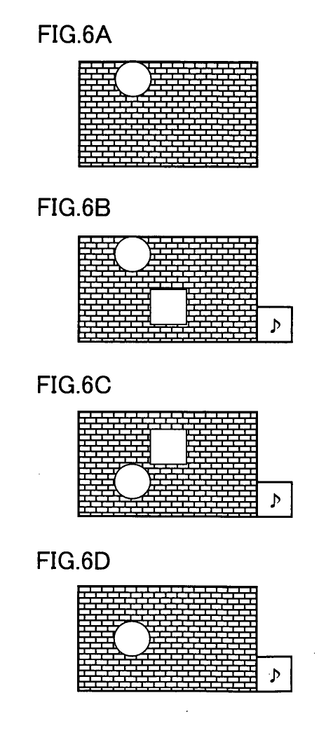

FIGS. 6A, 6B, 6C and 6D illustrate an animation displayed when contents data 3A synthesized in accordance with the first example of synthesis of the first embodiment is reproduced. FIGS. 6A to 6D show displayed images corresponding to respective key frames reproduced successively. Referring to FIG. 6A, first, in key frame 1, a circular figure is displayed at an upper portion of the image plane slightly left from the center, and an image A represented by image data is displayed as a background. Between key frames 1 and 2, the image displayed in the first key frame is kept continuously displayed.

Referring to FIG. 6B, in key frame 2, a square figure is additionally displayed at a portion slightly lower than the center of the image plane, and music A represented by music data starts. Between key frames 2 and 3, the circular figure moves downward, while the square figure moves upward.

Referring to FIG. 6C, in key frame 3, the circular figure is displayed at a portion slightly lower than and slightly left from the center of the image plane, and the square figure is displayed at a portion slightly upper than the center of the image plane. Between key frames 3 and 4, the circular figure moves upward and the square figure disappears gradually.

Referring to FIG. 6D, in key frame 4, the circular figure stops at a portion slightly left from the center of the image plane, and the square figure disappears completely. Though not shown in FIGS. 6A to 6D, when contents data 3A is reproduced by the reproducing apparatus, between the displayed images corresponding to respective frames, an image plane corresponding to an interpolated frame is displayed.

In this manner, the synthesizing script included in contents data 1A controls the synthesizing process of inserting the object data included in contents data 2 into contents data 1A. As a result, the synthesizing process of inserting other contents data 2A can be controlled from the side of contents data 1A.

(Second Example of Synthesis in Accordance with the First Embodiment)

Here, an example of synthesis of inserting prescribed data to a contents data will be described, in which based on a synthesizing script included in the contents data, data included in another contents data is inserted to the contents data.

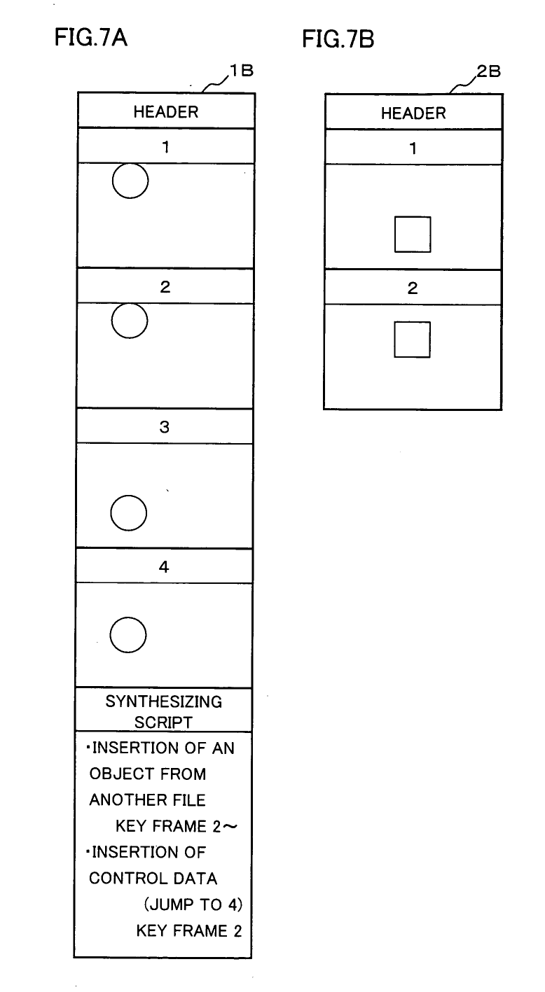

FIGS. 7A and 7B show data structures of the contents data before synthesis, in the second example of synthesis in accordance with the first embodiment. FIG. 7A represents data structure of contents data 1B including the synthesizing script. Referring to FIG. 7A, contents data 1B includes a header, key frames 1 to 4, and the synthesizing script.

Key frames 1 to 4 each include an object data. These object data are similar to the object data included in key frames 1 to 4 of contents data 1A described with reference to FIG. 4A, and therefore, description thereof will not be repeated.

The synthesizing script included in contents data 1B includes, as the first control contents, “insertion of object of another file,” and as the first parameter, “key frame 2˜”. Further, it includes, as the second control contents, “insertion of control data,” and as the second parameter, “(jump to 4) key frame 2.” As “insertion of object of another file” has already been described with reference to FIG. 4A, description thereof will not be repeated. The control contents “insertion of control data” represents insertion of the target data designated by the parameter in the parenthesis into the target position designated by the parameter outside the parenthesis. The parameter, “(jump to 4) key frame 2” indicates that the target data of the synthesizing process represented by the control contents is the control data “jump to 4” and that the target position of the synthesizing process represented by the control contents is key frame 2 of the animation data included in contents data 1B that includes the synthesizing script.

The control data refers to data for controlling the reproducing apparatus when the key frames of the animation data are reproduced. When the control data is included in the key frames of the contents data, the reproducing apparatus reproduces the key frames based on the control data, at the time of reproduction.

FIG. 7B represents data structure of contents data 2B. Contents data 2B shown in FIG. 7B is the same as contents data 2A described with reference to FIG. 4B, and therefore, description thereof will not be repeated.

Contents synthesizing apparatus 100 receives inputs of contents data 1B and 2B, and whether contents data 1B or 2B includes a synthesizing script or riot is determined. As contents data 1A includes the synthesizing script, the animation data included in contents data 1B is synthesized with animation data included in contents data 2B based on the synthesizing script, and contents data 3B, which will be described later, is stored.

Synthesizing script describes that to each key frame starting from key frame 2 of animation data 1B including the synthesizing script, the object data included in each key frame of the other animation data 2B, which will be described later, is to be inserted, and that the control data “jump to 4” designating a jump to key frame 4 is to be inserted to key frame 2 of animation data 1B.

Therefore, contents synthesizing apparatus 100 provides key frame 1 of contents data 1B as a new key frame 1.

Thereafter, the object data included in key frame 1 of contents data 2B and the control data “jump to 4” are inserted to key frame 2 of contents data 1B, to provide a new key frame 2.

Then, the object data included in key frame 2 of contents data 2B is inserted to key frame 3 of contents data 1B, to provide key frame 3 of contents data 3B.

Next, key frame 4 of contents data 1B will be a new key frame 4.

Finally, based on the new key frames 1 to 4, a header is generated, and contents data 3B including the header and the new key frames 1 to 4 is synthesized and stored.

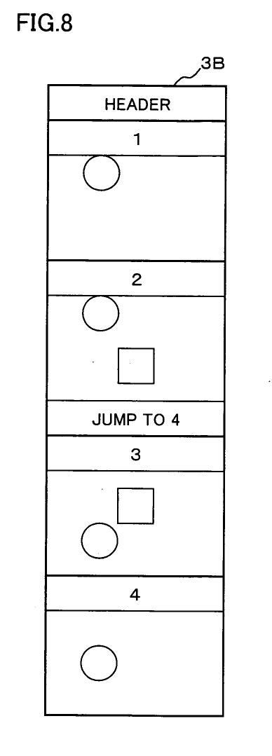

FIG. 8 shows data structure of the contents data 3B after synthesis, in the second example of synthesis in accordance with the first embodiment. Referring to FIG. 8, contents data 3B having contents data 1B and contents data 2B synthesized by contents synthesizing apparatus 100 consists of the header and key frames 1 to 4. The header has already been described with reference to FIG. 5, and therefore, description will not be repeated.

Key frame 1 is the same as key frame 1 of contents data 1B described with reference to FIG. 7A.

Key frame 2 is the key frame 2 of contents data 1B, having the object data included in key frame 1 of contents data 2B described with reference to FIG. 7B inserted, and having control data “jump to 4” inserted.

Key frame 3 is the key frame 3 of contents data 1B having the object data included in key frame 2 of contents data 2B inserted.

Key frame 4 is the same as key frame 4 of contents data 1B.

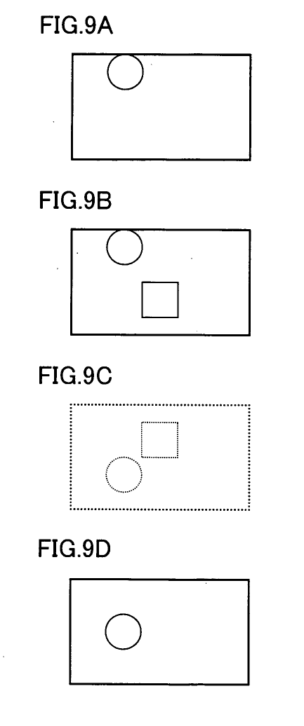

FIGS. 9A, 9B, 9C and 9D illustrate an animation displayed when contents data 3B synthesized in accordance with the second example of synthesis of the first embodiment is reproduced. FIGS. 9A to 9D show displayed images corresponding to respective key frames reproduced successively. Referring to FIG. 9A, first, in key frame 1, a circular figure is displayed at an upper portion of the image plane slightly left from the center. Between key frames 1 and 2, the image displayed in the first key frame is kept continuously displayed.

Referring to FIG. 9B, in key frame 2, a square figure is additionally displayed at a portion slightly lower than the center of the image plane. Referring to FIG. 9C, in accordance with the control data “jump to 4”, the key frame 3 is excluded from the object of reproduction. Between key frames 2 and 4, the circular figure moves downward, while the square figure disappears gradually.

Referring to FIG. 9D, in key frame 4, the circular figure stops at a portion slightly left from the center of the image plane, and the square figure disappears completely.

In this manner, the synthesizing script including a plurality of scripts included in contents data 1B controls the synthesizing process of synthesizing the object data included in contents data 2B with contents data 1B. As a result, the synthesizing process of synthesizing with the other contents data 2B can be controlled from the side of contents data 1B.

(Third Example of Synthesis in Accordance with the First Embodiment)

Here, an example of synthesis will be described in which, based on the synthesizing script included in a contents data, another contents data is inserted to the contents data.

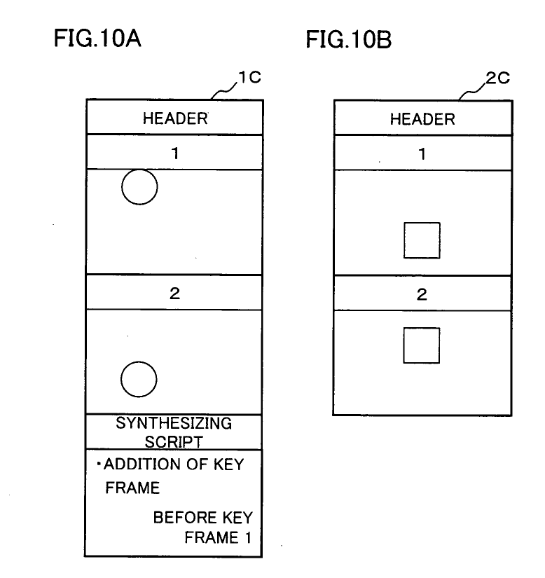

FIGS. 10A and 10B show data structures of the contents data before synthesis, in the third example of synthesis in accordance with the first embodiment. FIG. 10A represents data structure of contents data 1C including the synthesizing script. Referring to FIG. 110A, contents data 1C includes a header, key frames 1 and 2, and the synthesizing script.

Key frames 1 and 2 are similar to the object data included in key frames 2 and 3 of contents data 1B described with reference to FIG. 7A, respectively, and therefore, description thereof will not be repeated.

The synthesizing script included in contents data 2C includes, as control contents, “addition of key frame,” and as a parameter, “before key frame 1.” The control contents “addition of key frame” indicates that each key frame included in the animation data included in another contents data 2C is to be inserted to the target position designated by the parameter. The parameter “before key frame 1” represents that the target position of synthesizing process indicated by the control contents is before the key frame 1 of the animation data included in contents data 1C including the synthesizing script.

FIG. 10B represents data structure of contents data 2C. Referring to FIG. 10B, contents data 2C is the same as contents data 2B described with reference to FIG. 7B, and therefore, description thereof will not be repeated.

Contents synthesizing apparatus 100 receives inputs of contents data 1C and 2C, and whether contents data 1C or 2C includes a synthesizing script or not is determined. As contents data 1C includes the synthesizing script, the animation data included in contents data 1C is synthesized with animation data included in contents data 2C based on the synthesizing script, and contents data 3C, which will be described later, is stored.

The synthesizing script describes that the key frame included in contents data 2C should be added before key frame 1 of contents data 1C including the synthesizing script.

Therefore, contents synthesizing apparatus 100 adds key frames 1 and 2 of contents data 2C before key frame 1 of contents data 1C, to provide new key frames 1 and 2.

Then, key frames 1 and 2 of contents data 1C are provided as key frames 3 and 4 of contents data 3C.

Finally, based on the new key frames 1 to 4, a header is generated, and contents data 3C including the header and the new key frames 1 to 4 is synthesized and stored.

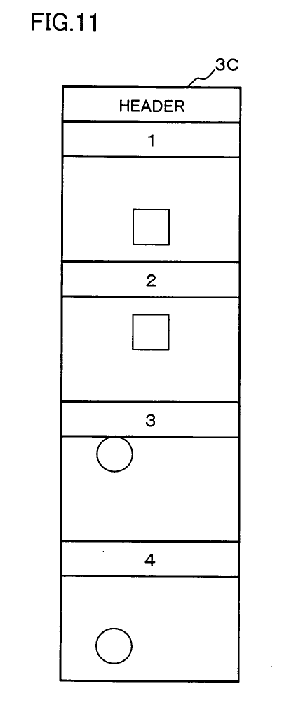

FIG. 11 shows data structure of the contents data 3C after synthesis, in the third example of synthesis in accordance with the first embodiment. Referring to FIG. 11, contents data 3C having contents data 1C and contents data 2C synthesized by contents synthesizing apparatus 100 consists of the header and key frames 1 to 4.

Key frames 1 and 2 are the same as key frames 1 and 2 of contents data 2C described with reference to FIG. 10B.

Key frames 3 and 4 are the same as key frames 1 and 2 of contents data 1C described with reference to FIG. 10A.

In this manner, the synthesizing script included in contents data 1C controls the synthesizing process of adding the key frame included in contents data 2C to a prescribed position of contents data 1C. As a result, the synthesizing process of inserting another contents data 2C can be controlled from the side of contents data 1C.

(Fourth Example of Synthesis in Accordance with the First Embodiment)

Here, an example of synthesis will be described, in which based on a synthesizing script included in a contents data, data included in the contents data is replaced by another contents data.

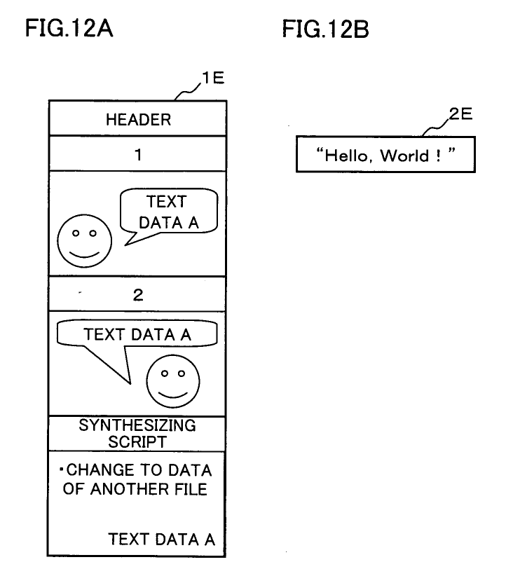

FIGS. 12A and 12B show data structures of the contents data before synthesis, in the fourth example of synthesis in accordance with the first embodiment. FIG. 12A represents data structure of contents data 1E including the synthesizing script. Referring to FIG. 12A, contents data 1E includes a header, key frames 1 and 2, and the synthesizing script.

Key frames 1 and 2 include an object data A representing a face figure, an object data B representing a dialogue balloon figure, and text data A.

Object data A included in key frame 1 represents that the face figure is at a lower left portion of the image plane. Further, object data A included in key frame 2 represents that the face figure is at a lower right portion of the image plane.

Object data B included in key frame 1 represents that the dialogue balloon figure is at an upper right portion of the image plane. Further, object data B included in key frame 2 represents that the dialogue balloon figure is at an upper portion of the image plane.

Text data A included in key frames 1 and 2 represent that the text data A is positioned inside object data B.

The synthesizing script included in contents data 1E includes, as control contents, “change to data of another file,” and as a parameter, “text data A.” The control contents “change to data of another file” indicates that the target data designated by the parameter should be changed to the data included in another contents data 2E. The parameter “text data A” indicates that the target data of the synthesizing process represented by the control contents is the text data A included in the key frame of animation data included in contents data 1E including the synthesizing script.

FIG. 12B shows contents data 2E for the change. Referring to FIG. 12B, contents data 2E includes text data consisting of a string of letters “Hello, World!”

Contents synthesizing apparatus 100 receives inputs of contents data 1E and 2E, and whether contents data 1E or 2E includes a synthesizing script or not is determined. As contents data 1E includes the synthesizing script, contents data 1E is synthesized with contents data 2E based on the synthesizing script, and contents data 3E, which will be described later, is stored.

The synthesizing script describes that the prescribed data included in the key frame of contents data 1E should be changed to data included in contents data 2E.

Therefore, based on the synthesizing script included in contents data 1E, contents synthesizing apparatus 100 changes the text data A included in key frames 1 and 2 of contents data 1E to the text data consisting of a string of letters “Hello, World!” included in contents data 2E, to provide new key frames 1 and 2.

Finally, based on the new key frames 1 and 2, a header is generated, and contents data 3E including the header and the new key frames 1 and 2 is synthesized and stored.

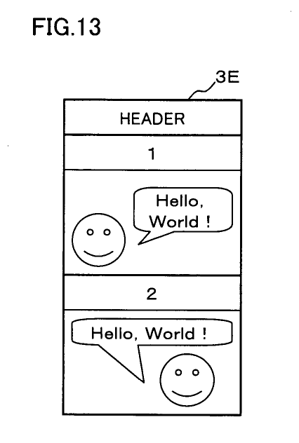

FIG. 13 shows data structure of the contents data 3E after synthesis, in the fourth example of synthesis in accordance with the first embodiment. Referring to FIG. 13, contents data 3E having contents data 1E and object data 2E synthesized by contents synthesizing apparatus 100 consists of the header and key frames 1 and 2.

Key frames 1 and 2 correspond to key frames 1 and 2 of contents data 1E described with reference to FIG. 12A, with the text data A changed to the text data included in contents data 2E described with reference to FIG. 12B.

In this manner, the synthesizing script included in contents data 1E controls the synthesizing process of changing the prescribed data included in contents data 1E to another data.

As described above, in the contents synthesizing apparatus 100 in accordance with the first embodiment, input of the first contents data including the synthesizing script describing synthesis of contents data and input of the second contents data are received, and the input first contents data is synthesized with the input second contents data. Therefore, the synthesizing script included in the first contents data controls the synthesizing process. Further, as the synthesizing script is included in the first contents data, it is unnecessary to newly prepare the synthesizing script when the first contents data is to be synthesized with the second contents data. As a result, the synthesizing process can be controlled from the side of the contents data and the necessity of newly preparing the synthesizing script required for synthesizing contents data can be eliminated.

Though the process performed by contents synthesizing apparatus 100 has been described in the first embodiment, the present invention can also be implemented as a method of synthesizing contents executing the process shown in FIG. 3 on a computer, a contents synthesizing program for causing a computer to execute the process shown in FIG. 3, a computer readable recording medium recording the contents synthesizing program, data structure of the contents data shown in FIGS. 4A, 7A, 10A and 12A, and a computer readable recording medium recording the contents data having the data structure.

### Second Embodiment

In the second embodiment, an example will be described in which the synthesizing script described with reference to the first embodiment includes scripts corresponding to a plurality of attributes respectively.

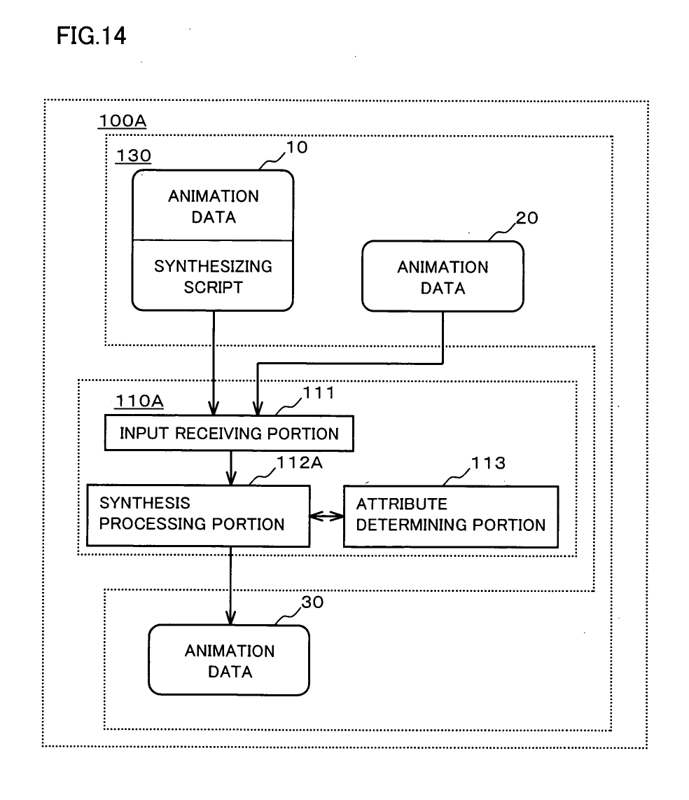

FIG. 14 schematically shows a function of contents synthesizing apparatus 100A in accordance with the second embodiment. Referring to FIG. 14, a control portion 110A of contents synthesizing apparatus 100A includes an input receiving portion 111, a synthesis processing portion 112A, and an attribute determining portion 113. Storage portion 130 of contents synthesizing apparatus 100 stores a plurality of contents data. The contents data includes contents data including animation data and a synthesizing script, and contents data including animation data.

Input receiving portion 111 has been described with reference to FIG. 2 of the first embodiment, and therefore, description thereof will not be repeated.

When the synthesizing script included in contents data 10 includes scripts corresponding to a plurality of attributes of the animation data included in contents data 20, respectively, synthesis processing portion 112A sends contents data 20 to attribute determining portion 113.

Attribute determining portion 113 determines attributes of animation data included in contents data 20 sent from synthesis processing portion 112A, and returns the result of determination to synthesis processing portion 112A. The attribute of animation data represents indexes showing the feature of animation data, such as the number of object data, number of key frames, number of image data and number of music data.

Specifically, when the number of object data included in contents data 20 is W, the number of key frames is X, the number of image data is Y and the number of music data is Z, for example, attribute determining portion 113 returns a string of numbers WXYZ as the attribute of animation data included in contents data 20, to synthesis processing portion 112A. The attributes of animation data are not limited thereto, and may include a number designated based on the contents of the animation data, information of the author of the animation data, a number uniquely allocated to the animation data, or a combination of these.

Based on the scripts corresponding to the attributes of animation data included in contents data 20 indicated by the result of determination made by attribute determining portion 113, synthesis processing portion 112A synthesizes the animation data included in contents data 10 input through input receiving portion 111 with the animation data included in contents data 20. Synthesis processing portion 112A then has the synthesized contents data 30 stored in storage portion 130. Synthesis processing portion 112A may directly transmit the synthesized contents data 30 to other PC or the like through network 500 using communication portion 160, or record the contents data on a recording medium 171, using external storage apparatus 170.

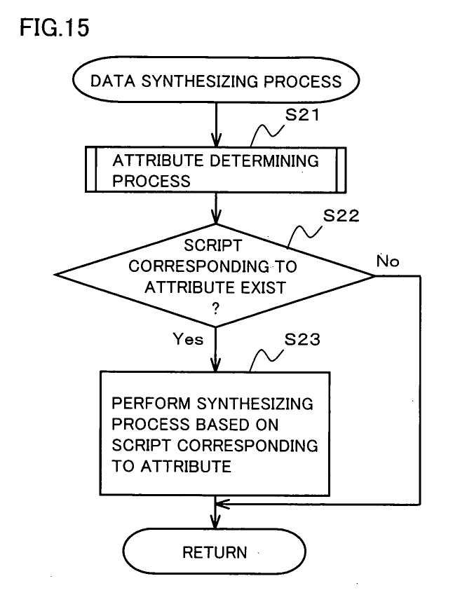

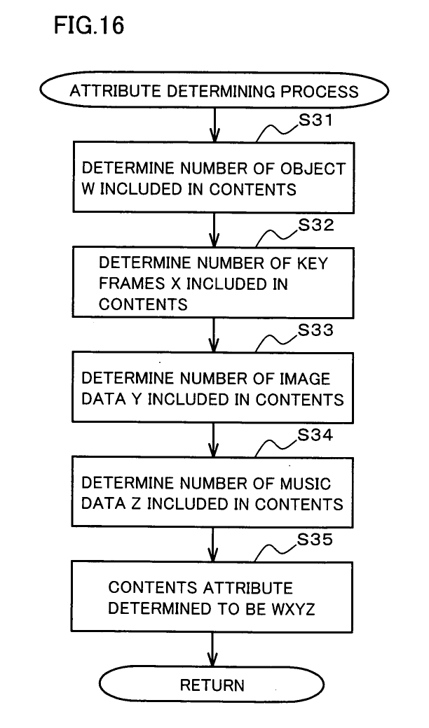

FIG. 15 is a flowchart representing the flow of data synthesizing process executed by contents synthesizing apparatus 100A in accordance with the second embodiment. The data synthesizing process is the process executed in step S13 of contents synthesizing process described with reference to FIG. 3. Referring to FIG. 15, first, in step S21, an attribute determining process for determining attributes of animation data included in contents data 20 input in step S11 is executed, by attribute determining portion 113. The attribute determining process will be described later, with reference to FIG. 16.

Next, in step S22, synthesis processing portion 112A determines whether the script corresponding to the attribute of animation data included in contents data 20 determined in step S21 is included in the synthesizing script of contents data 10 or not. If the script corresponding to the attribute of animation data included in contents data 20 is included in the synthesizing script of content data 10 (Yes in step S22), in step S23, synthesis processing portion 112A executes a synthesizing process of synthesizing contents data 10 input in step S11 with contents data 20 input in step S11, based on the script corresponding to the attribute of animation data included in contents data 20, as determined in step S21, and then the flow returns to the contents synthesizing process.

If a script corresponding to the attribute of animation data included in contents data 20 is not included in the synthesizing script of contents data 10 (No in step S22), the flow returns to the contents synthesizing process.

FIG. 16 is a flowchart representing the flow of attribute determining process executed by contents synthesizing apparatus 100A in accordance with the second embodiment. The attribute determining process is executed by attribute determining portion 113 in step S21 of the data synthesizing process described with reference to FIG. 15. Referring to FIG. 16, first in step S31, the number of objects W included in the key frame of contents data 20 is determined. In step S32, the number of key frames X included in contents data 20 is determined.

In step S33, the number of image data Y included in the key frame of contents data 20 is determined. Further, in step S34, the number of music data Z included in the key frame of contents data 20 is determined.

Finally, in step S35, based on the determination of steps S31 to S34, a string of numbers WXYZ is returned to the data synthesizing process, as the attribute of animation data defined by the key frames included in contents data 20.

(First Example of Synthesis in Accordance with the Second Embodiment)

Here, an example of synthesis will be described, in which contents data is synthesized with another contents data, based on scripts corresponding to a plurality of attributes, included in the synthesizing script of the contents data.

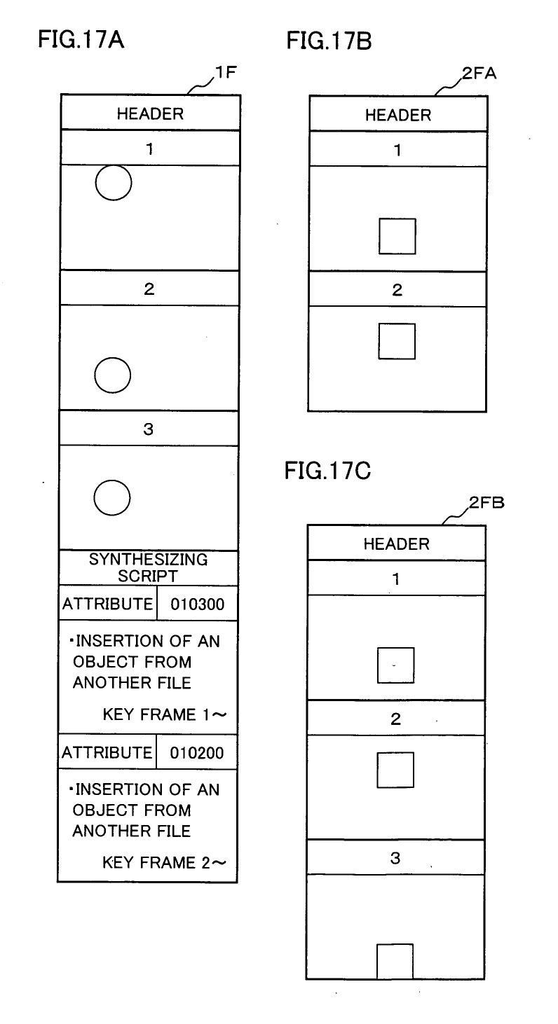

FIGS. 17A, 17B and 17C show data structures of the contents data before synthesis, in the first example of synthesis in accordance with the second embodiment. FIG. 17A shows the data structure of contents data 1F including the synthesizing script. Referring to FIG. 17A, contents data 1F includes a header, key frames 1 to 3, and the synthesizing script.

Key frames 1 to 3 are similar to the object data included in key frames 2 to 4 of contents data 1B described with reference to FIG. 7, and therefore, description thereof will not be repeated.

The synthesizing script included in contents data 1F includes a synthesizing script corresponding to the attribute “010300” and a synthesizing script corresponding to the attribute “010200”. The synthesizing script corresponding to the attribute “010300” includes, as control contents, “insertion of an object from another file”, and as a parameter, “key frame 1”. The synthesizing script corresponding to the attribute “010200” includes, as control contents, “insertion of an object from another file”, and as a parameter, “key frame 2˜”.

The control contents “insertion of an object from another file” and parameters “key frame 1˜” and “key frame 2˜” have already been described with reference to FIG. 4A, and therefore, description thereof will not be repeated.

The attribute “010300” indicates that the number of object data W included in the animation data is 01, the number of key frames X is 03, the number of image data Y is 0, and the number of music data Z is 0. Similarly, the attribute “010200” indicates that the numbers of object data, image data, and music data are the same as attribute “010300” while the number of key frames X is 02.

FIG. 17B shows a data structure of contents data 2FA. Contents data 2FA shown in FIG. 17B is the same as contents data 2A described with reference to FIG. 4B, and therefore, description thereof will not be repeated. Here, the number of object data W included in the animation data of contents data 2FA is 01, the number of key frames X is 02, the number of image data Y is 0 and the number of music data Z is 0, and therefore, the attribute of animation data included in contents data 2FA is “010200”.

FIG. 17C represents data structure of contents data 2FB. Referring to FIG. 17C, contents data 2FB includes a header and key frames 1 to 3.

Key frames 1 and 2 are the same as key frames 1 and 2 of contents data 2A described with reference to FIG. 4B.

Key frame 3 includes the object data representing the same figure as represented by the object data included in key frames 1 and 2, with the figure positioned at a lower center of the image plane.

Here, the number of object data W included in the animation data of contents data 2FB is 01, the number of key frames X is 03, the number of image data Y is 0 and the number of music data Z is 0, and therefore, the attribute of animation data included in contents data 2FA is “010300”.

First, an example will be described, in which contents data 1F and 2FA are input to contents data synthesizing apparatus 100A. Here, contents synthesizing apparatus 100A determines whether contents data 1F or contents data 2FA includes a synthesizing script or not. As the synthesizing script is included in contents data 1F, next, attribute of animation data included in contents data 2FA is determined. The attribute of animation data included in contents data 2FA is “010200”, and therefore, the animation data included in contents data 1F is synthesized with contents data 2FA based on the script corresponding to the attribute “010200”, and new contents data is stored.

Next, an example will be described, in which contents data 1F and 2FB are input to contents synthesizing apparatus 100A. Here, contents synthesizing apparatus 100A determines whether contents data 1F or contents data 2FB includes a synthesizing script or not. As the synthesizing script is included in contents data 1F, next, attribute of animation data included in contents data 2FB is determined. The attribute of animation data included in contents data 2FB is “010300”, the animation data included in contents data 1F is synthesized with contents data 2FB based on the script corresponding to the attribute “010300”, and new contents data is stored.

The synthesizing script included scripts corresponding to attributes “010200” and “010300”, respectively. The script corresponding to attribute “010300” describes that the to each key frame starting from key frame 1 of the animation data included in contents data including the synthesizing script, the object data included in each key frame of the animation data included in contents data 2FA including animation data having the attribute “010300” should be inserted.

Further, the script corresponding to attribute “010200” describes that to each key frame starting from key frame 2 of the animation data included in contents data 1F including the synthesizing script, the object data included in each key frame of the animation data included in contents data 2FB including animation data having the attribute “010200” should be inserted.

As a result, when contents data 1F and 2FA are input, contents synthesizing apparatus 100 provides key frame 1 of contents data 1F as a new key frame 1.

Next, the object data included in key frame 1 of contents data 2FA is inserted to key frame 2 of contents data 1F, to provide a new key frame 2.

Next, the object data included in key frame 2 of contents data 2FA is inserted to key frame 3 of contents data 1F, to provide a new key frame 3.

Finally, based on the new key frames 1 to 3, a header is generated, and contents data including the header and new key frames 1 to 3 is synthesized and stored.

When contents data 1F and 2FB are input, contents synthesizing apparatus 100 inserts the object data included in key frame 1 of contents data 2FB into key frame 1 of contents data 1F, to provide a new key frame 1.

Next, the object data included in key frame 2 of contents data 2FB is inserted to key frame 2 of contents data 1F, to provide a new key frame 2.

Next, the object data included in key frame 3 of contents data 2FB is inserted to key frame 3 of contents data 1F, to provide a new key frame 3.

Finally, based on the new key frames 1 to 3, a header is generated, and contents data including the header and the new key frames 1 to 3 is synthesized and stored.

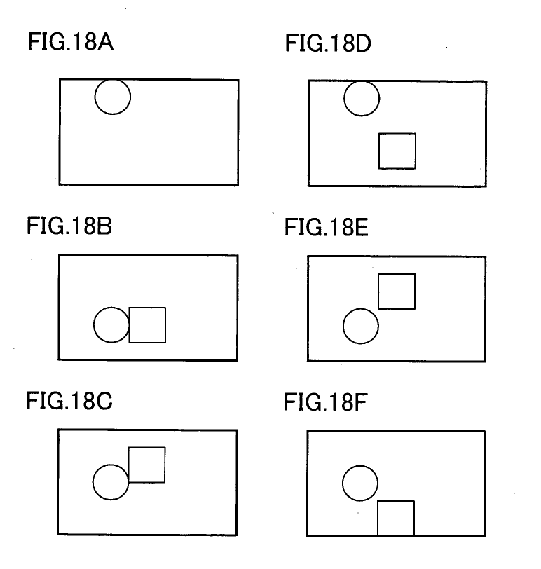

FIGS. 18A, 18B, 18C, 18D, 18E, and 18F illustrate animation displayed when the contents data synthesized in accordance with the first example of synthesis of the second embodiment are reproduced. FIGS. 18A to 18C show display images corresponding to respective key frames reproduced successively, when the contents data resulting from synthesis of contents data 1F with contents data 2FA including animation data having the attribute “010200” is reproduced.

Referring to FIG. 18A, first, a circular figure is displayed at an upper portion of the image plane, slightly left from the center. Between FIGS. 18A and 18B, the circular image moves downward. In FIG. 18B, the circular figure is displayed at a portion slightly lower than the center and slightly left from the center of the image plane, and a square figure is displayed slightly lower from the center of the image plane. Between FIGS. 18B and 18C, the circular figure moves upward, and the square figure moves upward faster than the circular figure. In FIG. 18C, the circular figure is stopped slightly left from the center of the image, and the square figure stops slightly upper from the center of the image plane.

FIGS. 18D to 18F show display images corresponding to respective key frames reproduced successively, when the contents data resulting from synthesis of contents data 1F with contents data 2FB including animation data having the attribute “010300” is reproduced.

Referring to FIG. 18D, first, the circular figure is displayed at an upper portion of the image plane, slightly left from the center. Between FIGS. 18D and 18E, the circular figure moves downward, and the square figure moves upward. In FIG. 18E, the circular figure is displayed slightly lower than the center and slightly left from the center of the image plane, and the square figure is displayed slightly upper than the center of the image plane. Between FIGS. 18E and 18F, the circular figure moves upward, and the square figure moves downward. In FIG. 18F, the circular figure is stopped slightly left from the center of the image plane, and the square figure is stopped at a lower center of the image plane.

In this manner, based on the script corresponding to the determined attribute included in the synthesizing script included in contents data 1F, the synthesizing process of synthesizing contents data 1F with another contents data can be controlled. As a result, the synthesizing process can be controlled from the side of the contents data, and the synthesizing process appropriate for the attribute of contents data becomes possible.

In the second embodiment, the attribute of contents data is described as attribute of animation data defined by the key frame included in the contents data. The attribute, however, is not limited thereto, and any index representing the feature of the contents data may be used.

As described above, in the contents synthesizing apparatus 100A in accordance with the second embodiment, input of the first contents data including the synthesizing script describing synthesis of contents data and input of the second contents data are received, attribute of the input second contents data is determined, and based on the script corresponding to the determined attribute included in the synthesizing script included in the input first contents data, the first contents data is synthesized with the second contents data. Therefore, the synthesizing process is controlled by the script corresponding to the attribute of the second contents data. As a result, the synthesizing process can be controlled from the side of the contents data, and the synthesizing process appropriate for the attribute of contents data becomes possible.

Though the process performed by contents synthesizing apparatus 100A has been described in the second embodiment, the present invention can also be implemented as a method of synthesizing contents executing the process shown in FIGS. 15 and 16 on a computer, a contents synthesizing program for causing a computer to execute the process shown in FIGS. 15 and 16, a computer readable recording medium recording the contents synthesizing program, data structure of the contents data shown in FIG. 17A, and a computer readable recording medium recording the contents data having the data structure.

### Third Embodiment

In the third embodiment, an example will be described, in which the synthesizing script described with reference to the first embodiment includes a script dependent on time of synthesis by the contents synthesizing apparatus 100B.

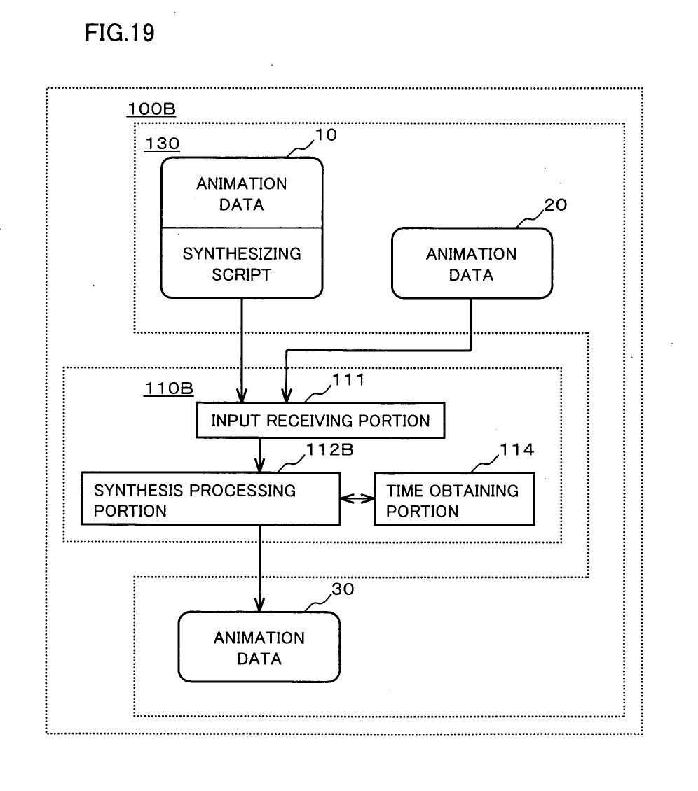

FIG. 19 schematically shows functions of the contents synthesizing apparatus 100B in accordance with a third embodiment. Referring to FIG. 19, control portion 110B of contents synthesizing apparatus 100B includes an input receiving portion 111, a synthesis processing portion 112B, and a time obtaining portion 114. Storage portion 130 of contents synthesizing apparatus 100B stores a plurality of contents data. The contents data includes contents data including animation data and a synthesizing script, and contents data including animation data. Input receiving portion 111 has already been described with reference to FIG. 2 of the first embodiment, and therefore, description will not be repeated.

When the synthesizing script included in contents data 10 includes a script that depends on the time of synthesis of the contents data, synthesis processing portion 112B instructs time obtaining portion 114 to obtain time.

In response to the instruction from synthesis processing portion 112B, time obtaining portion 114 obtains current time, and sends the time to synthesis processing portion 112B. The current time may be obtained, by way of example, by a timer function of contents synthesizing apparatus 100B, or by other method.

Synthesis processing portion 112B synthesizes contents data 10 input through input receiving portion 111 with contents data 20 input through input receiving portion 111, based on the script corresponding to the time obtained by time obtaining portion 114, of the synthesizing script included in contents data 10. Synthesis processing portion 112B has synthesized contents data 30 stored in storage portion 130. Synthesis processing portion 112B may directly send the synthesized contents data 30 to other PC or the like through network 500 using communication portion 160, or store the same on recording medium 171 using external storage apparatus 170.

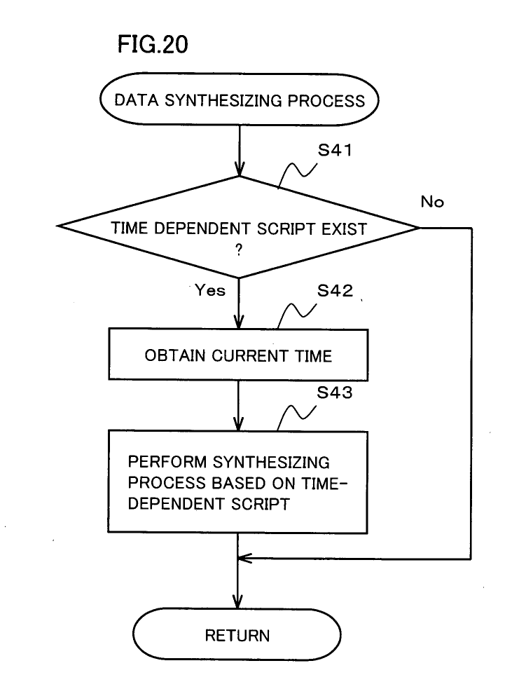

FIG. 20 is a flowchart representing a flow of a data synthesizing process executed by the contents synthesizing apparatus 100B in accordance with the third embodiment. The data synthesizing process is the process executed in step S13 of contents synthesizing process described with reference to FIG. 3. Referring to FIG. 20, first, in step S41, whether the synthesizing script includes a time-dependent script or not is determined. When the synthesizing script includes a time-dependent script (Yes in step S41), in step S42, time obtaining portion 114 obtains current time, and in step S43, synthesis processing portion 112B executes a synthesizing process of synthesizing contents data 10 input in step S11 with contents data 20 input in step S11, based on the script corresponding to the current time obtained in step S42, and then the flow returns to the contents synthesizing process.

If the synthesizing script does not include any time-dependent script (No in step S41), the flow returns to the contents synthesizing process.

(First Example of Synthesis in Accordance with the Third Embodiment)

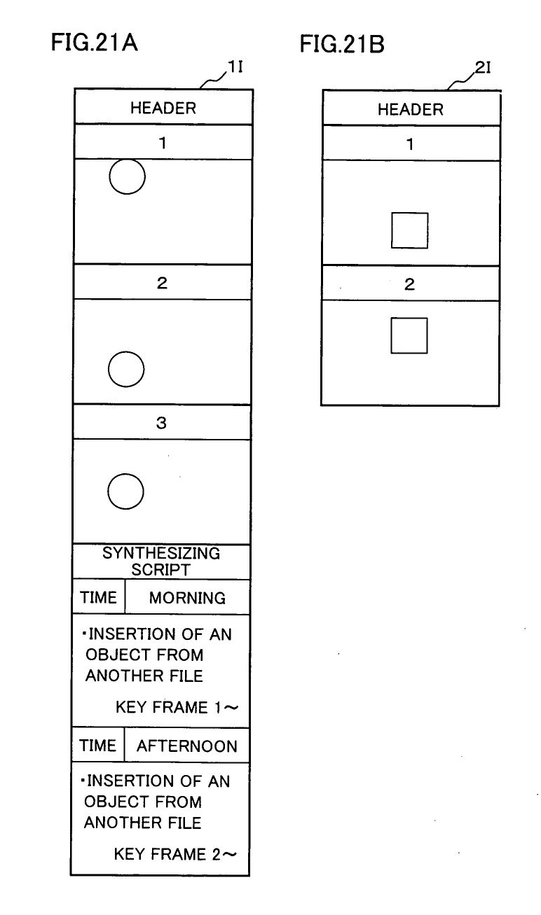

FIGS. 21A and 21B show data structures of the contents data before synthesis, in the first example of synthesis in accordance with the third embodiment. FIG. 21A shows data structure of contents data 11 including the synthesizing script. Referring to FIG. 21A, contents data 11 includes a header, key frames 1 to 3 and a synthesizing script.

Key frames 1 to 3 are the same as key frames 1 to 3 of contents data 1F described with reference to FIG. 17A, and therefore, description will not be repeated.

The synthesizing script included in contents data 1I includes a synthesizing script corresponding to time “morning” and a synthesizing script corresponding to time “afternoon”. The synthesizing script corresponding to time “morning” includes, as control contents, “insertion of an object from another file”, and as a parameter, “key frame 1˜”. Further, the synthesizing script corresponding to time “afternoon” includes, as control contents, “insertion of an object from another file”, and as a parameter, “key frame 2˜”. Control contents “insertion of an object from another file” and parameters “key frame 1˜” and “key frame 2˜” have already been described with reference to FIG. 4A, and therefore, description thereof will not be repeated.

FIG. 21B shows data structure of contents data 21. Contents data 21 shown in FIG. 21B is the same as contents data 2A described with reference to FIG. 4B, and therefore, description thereof will not be repeated.

First, an example will be described, in which synthesis of contents data 1I and contents data 2I by contents synthesizing apparatus 100B takes place in the morning. Here, contents synthesizing apparatus 100B receives input of contents data 11 and 21. As the synthesizing script is included in contents data 11 and the time of synthesis is in the morning, object data included in each key frame of contents data 21 is inserted to each key frame starting from key frame 1 of contents data 1I, based on the script corresponding to the morning, and a new contents data is stored.

Next, an example will be described, in which synthesis of contents data 1I and contents data 21 by contents synthesizing apparatus 100B takes place in the afternoon. Here, contents synthesizing apparatus 100B receives input of contents data 1I and 2I. As the synthesizing script is included in contents data 1I and the time of synthesis is in the afternoon, object data included in each key frame of contents data 2I is inserted to each key frame starting from key frame 2 of contents data 1I, based on the script corresponding to the afternoon, and a new contents data is stored.

The synthesizing script includes scripts corresponding to the morning and the afternoon. The script corresponding to the morning describes that to each key frame from key frame 1 of contents data 1I including the synthesizing script, the object data included in each key frame of contents data 21 should be inserted. The script corresponding to the afternoon describes that to each key frame from key frame 2 of contents data 11 including the synthesizing script, the object data included in each key frame of contents data 2I should be inserted.

Therefore, when the time of synthesis is in the morning, contents synthesizing apparatus 100B inserts the object data included in key frame 1 of contents data 2I into key frame 1 of contents data 1I, to provide a new key frame 1.

Thereafter, the object data included in key frame 2 of contents data 2I is inserted to key frame 2 of contents data 1I, to provided key frame 2 of the new contents data.

Thereafter, key frame 3 of contents data 1I is provided as key frame 3 of the new contents data.

Finally, based on the new key frames 1 to 3, a header is generated, and the contents data including the header and the new key frames 1 to 3 is synthesized and stored.

When the time of synthesis is in the afternoon, contents synthesizing apparatus 100B provides key frame 1 of contents data 1I as a new key frame 1.

Next, the object data included in key frame 1 of contents data 2I is inserted to key frame 2 of contents data 1I, to provide a new key frame 2.

Thereafter, the object data included in key frame 2 of contents data 2I is inserted to key frame 3 of contents data 1I, to provide key frame 3 of the new contents data.

Finally, based on the new key frames 1 to 3, a header is generated, and the contents data including the header and the new key frames 1 to 3 is synthesized and stored.

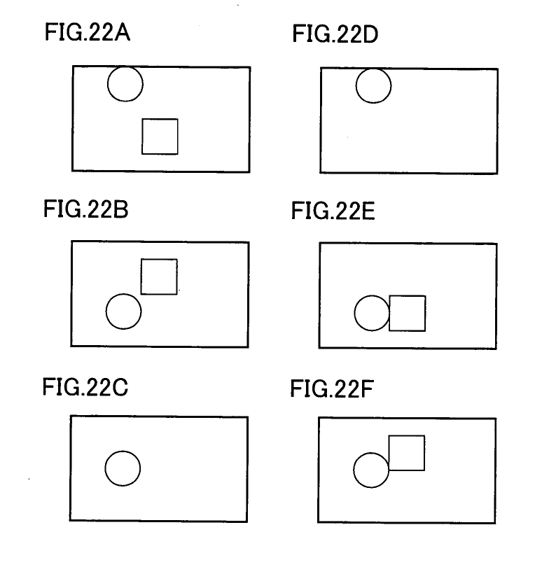

FIGS. 22A, 22B, 22C, 22D, 22E, and 22F illustrate animation displayed when the contents data synthesized in accordance with the first example of synthesis of the third embodiment are reproduced. FIGS. 22A to 22C represent display images corresponding to respective key frames reproduced successively, when the contents data resulting from synthesis of contents data 1I and 2I in the morning are reproduced. FIGS. 22A to 22C are the same as FIGS. 18D to 18F, respectively, and therefore, description thereof will not be repeated.

FIGS. 22D to 22F represent display images corresponding to respective key frames reproduced successively, when the contents data resulting from synthesis of contents data 1I and 2I in the afternoon are reproduced. FIGS. 22D to 22F are the same as FIGS. 18A to 18F, respectively, and therefore, description thereof will not be repeated.

In this manner, the synthesizing process is controlled by the script corresponding to the time of synthesis included in contents data 1I. As a result, the synthesizing process can be controlled from the side of the contents data 1I, and the synthesizing process appropriate for the time of synthesizing the contents data becomes possible.

As described above, in the contents synthesizing apparatus 100B in accordance with the third embodiment, input of the first contents data including the synthesizing script describing synthesis of contents data and input of the second contents data are received, current time is obtained, and based on the script corresponding to the current time included in the synthesizing script included in the input first contents data, the first contents data is synthesized with the second contents data. Therefore, the synthesizing process is controlled by the script corresponding to the time of synthesis. As a result, the synthesizing process can be controlled from the side of the contents data and the synthesizing process appropriate for the time of synthesizing the contents data becomes possible.

Though the process performed by contents synthesizing apparatus 100B has been described in the third embodiment, the present invention can also be implemented as a method of synthesizing contents executing the process shown in FIG. 20 on a computer, a contents synthesizing program for causing a computer to execute the process shown in FIG. 20, a computer readable recording medium recording the contents synthesizing program, data structure of the contents data shown in FIG. 21A, and a computer readable recording medium recording the contents data having the data structure.

### Fourth Embodiment

In the fourth embodiment, an example will be described, in which the synthesizing script described with respect to the first embodiment includes a script corresponding to a position of synthesis by a contents synthesizing apparatus 100C.

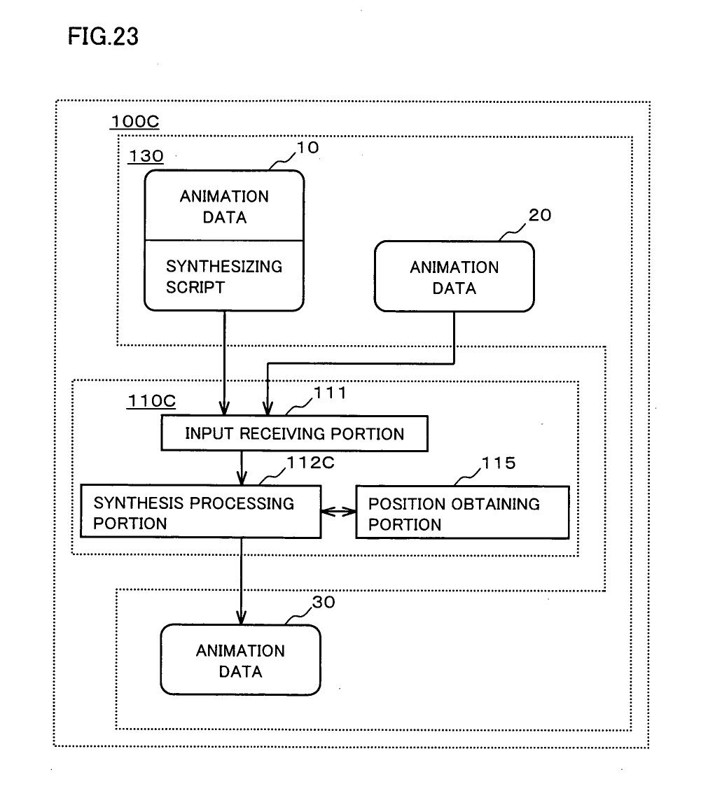

FIG. 23 schematically shows functions of the contents synthesizing apparatus 100C in accordance with a fourth embodiment. Referring to FIG. 23, a control portion 110C of contents synthesizing apparatus 100C includes an input receiving portion 111, a synthesis processing portion 112C, and a position obtaining portion 115. Storage portion 130 of contents synthesizing apparatus 100C stores a plurality of contents data. The contents data includes contents data including animation data and a synthesizing script, and contents data including animation data. Input receiving portion 111 has already been described with reference to FIG. 2 of the first embodiment, and therefore, description thereof will not be repeated.

When the synthesizing script included in contents data 10 input through input receiving portion 111 includes a script corresponding to a position of synthesis of the contents data, synthesis processing portion 112C instructs position obtaining portion 115 to obtain a position.

In response to the instruction from synthesis processing portion 112C, position obtaining portion 115 obtains the current position of content synthesizing apparatus 100C, and sends the position to synthesis processing portion 112C. The current position may be obtained, for example, by a GPS (Global Positioning System) or it may be obtained by other method.

Synthesis processing portion 112C synthesizes contents data 10 input through input receiving portion 111 with contents data 20 input through input receiving portion 111, based on the script corresponding to the position obtained by position obtaining portion 115, of the synthesizing script included in contents data 10. Synthesis processing portion 112C has synthesized contents data 30 stored in storage portion 130. Synthesis processing portion 112C may directly transmit the synthesized contents data 30 to other PC or the like through network 500 using communication portion 160, or store the same on recording medium 171 using external storage apparatus 170.

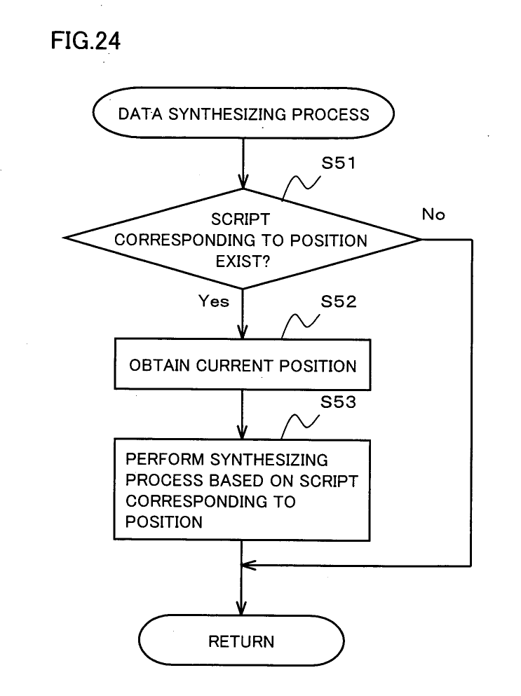

FIG. 24 is a flowchart representing a flow of a data synthesizing process executed by the contents synthesizing apparatus 100C in accordance with the fourth embodiment. The data synthesizing process is the process executed in step S13 of contents synthesizing process described with reference to FIG. 3. Referring to FIG. 24, first, in step S51, whether the synthesizing script includes a position-dependent script or not is determined. When the synthesizing script includes a position-dependent script (Yes in step S51), position obtaining portion 115 obtains the current position in step S52, and in step S53, synthesis processing portion 112C executes a synthesizing process of synthesizing contents data 10 input in step S11 with contents data 20 input in step S11, based on the script dependent on the current position obtained in step S53, and then the flow returns to the contents synthesizing process.

If the synthesizing script does not include any position-dependent script (No in step S51), the flow returns to the contents synthesizing process.

(First Example of Synthesis in Accordance with the Fourth Embodiment)

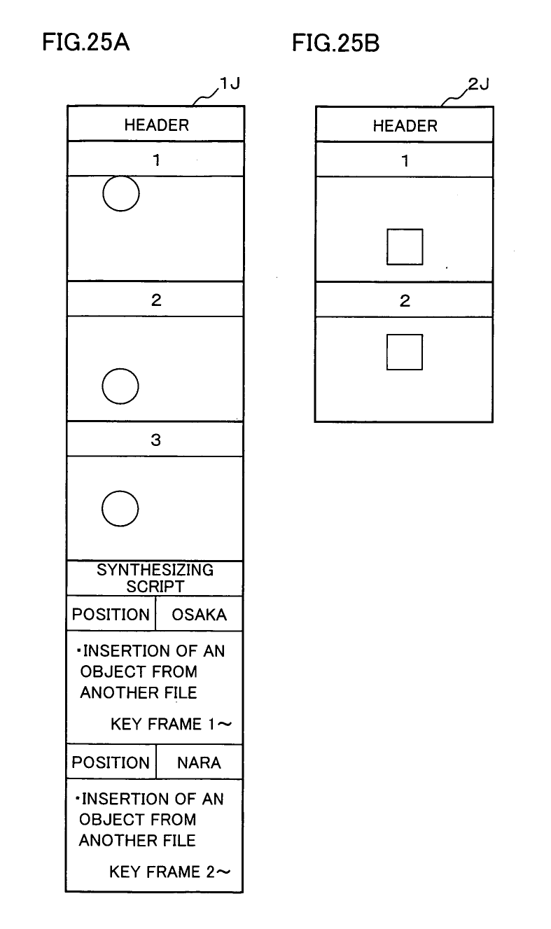

FIGS. 25A and 25B show data structures of the contents data before synthesis, in the first example of synthesis in accordance with the fourth embodiment. Referring to FIG. 25A, contents data 1J including the synthesizing script includes a header, key frames 1 to 3 and the synthesizing script.

Key frames 1 to 3 are the same as key frames 1 to 3 of contents data 1F described with reference to FIG. 17A, and therefore, description thereof will not be repeated.

The synthesizing script included in contents data 1J includes a synthesizing script corresponding to the position “Osaka” and includes a synthesizing script corresponding to the position “Nara”. The synthesizing script corresponding to the position “Osaka” includes, as control contents, “insertion of an object from another file”, and as a parameter, “key frame 1˜”. The synthesizing script corresponding to the position “Nara” includes, as control contents, “insertion of an object from another file”, and as a parameter, “key frame 2˜”. Control contents “insertion of an object from another file” and parameters “key frame 1˜” and “key frame 2˜” have already been described with reference to FIG. 4A, and therefore, description thereof will not be repeated.

FIG. 25B shows data structure of contents data 2J. Contents data 2J shown in FIG. 25B is the same as contents data 2A described with reference to FIG. 4B, and therefore, description thereof will not be repeated.

First, an example will be described, in which the position of synthesis of contents data 1J and 2J by contents data synthesizing apparatus 100C is Osaka. Here, contents synthesizing apparatus 100C receives input of contents data 1J and 2J. As the synthesizing script is included in contents data 1J and the position of synthesis is Osaka, object data included in each key frame of contents data 2J is inserted to each key frame from key frame 1 of contents data 1J, based on the script corresponding to Osaka, and a new contents data is stored. Display images corresponding to respective key frames reproduced successively, when the animation data resulting from synthesis of contents data 1J and 2J in Osaka is reproduced, are the same as FIGS. 18D to 18F, and therefore, description thereof will not be repeated.

Next, an example will be described, in which the position of synthesis of contents data 1J and 2J by contents data synthesizing apparatus 100C is Nara. Here, contents synthesizing apparatus 100C receives input of contents data 1J and 2J. As the synthesizing script is included in contents data 1J and the position of synthesis is Nara, object data included in each key frame of contents data 2J is inserted to each key frame from key frame 2 of contents data 1J, based on the script corresponding to Nara, and a new contents data is stored. Display images corresponding to respective key frames reproduced successively, when the animation data resulting from synthesis of contents data 1J and 2J in Nara is reproduced, are the same as FIGS. 18A to 18C, and therefore, description thereof will not be repeated.

The synthesizing script includes scripts corresponding Osaka and Nara. The script corresponding to Osaka describes that to each key frame from key frame 1 of contents data 1J including the synthesizing script, the object data included in each key frame of contents data 2J should be inserted. The script corresponding to Nara describes that to each key frame from key frame 2 of contents data 1J including the synthesizing script, the object data included in each key frame of contents data 2J should be inserted.

Therefore, when the position of synthesis is Osaka, contents synthesizing apparatus 100C inserts the object data included in key frame 1 of contents data 2J into key frame 1 of contents data 1J, to provide a new key frame 1.

Thereafter, the object data included in key frame 2 of contents data 2J is inserted to key frame 2 of contents data 1J, to provided a new key frame 2.

Thereafter, key frame 3 of contents data 1J is provided as a new key frame 3.

Finally, based on the new key frames 1 to 3, a header is generated, and the contents data including the header and the new key frames 1 to 3 is synthesized and stored.

When the position of synthesis is Nara, contents synthesizing apparatus 100C provides key frame 1 of contents data 1J as a new key frame 1.

Next, the object data included in key frame 1 of contents data 2J is inserted to key frame 2 of contents data 1J, to provide a new key frame 2.

Thereafter, the object data included in key frame 2 of contents data 2J is inserted to key frame 3 of contents data 1J, to provide a new key frame 3.

Finally, based on the new key frames 1 to 3, a header is generated, and the contents data including the header and the new key frames 1 to 3 is synthesized and stored.

The display images corresponding to respective key frames reproduced successively, when the contents data resulting from synthesis of contents data 1J and 2J in Osaka are reproduced are the images shown in FIGS. 18D to 18F. The display images corresponding to respective key frames reproduced successively, when the contents data resulting from synthesis of contents data 1J and 2J in Nara are reproduced are the images shown in FIGS. 18A to 18C.

As described above, in the contents synthesizing apparatus 100C in accordance with the fourth embodiment, input of the first contents data including the synthesizing script describing synthesis of contents data and input of the second contents data are received, current position of contents synthesizing apparatus 100C is obtained, and based on the script corresponding to the obtained current position included in the synthesizing script included in the input first contents data, the first contents data is synthesized with the second contents data. Therefore, the synthesizing process is controlled by the script corresponding to the place of synthesis. As a result, the synthesizing process can be controlled from the side of the contents data and the synthesizing process appropriate for the place of synthesizing the contents data becomes possible.

Though the process performed by contents synthesizing apparatus 100C has been described in the fourth embodiment, the present invention can also be implemented as a method of synthesizing contents executing the process shown in FIG. 24 on a computer, a contents synthesizing program for causing a computer to execute the process shown in FIG. 24, a computer readable recording medium recording the contents synthesizing program, data structure of the contents data shown in FIG. 25A, and a computer readable recording medium recording the contents data having the data structure.

### Fifth Embodiment

In the fifth embodiment, an example of synthesis will be described in which animation data is encrypted and an example of synthesis in which encrypted animation data is decoded, based on synthesizing scripts included in the contents data.

The function of the contents synthesizing apparatus in accordance with the fifth embodiment is the same as those of contents synthesizing apparatus 100 described with reference to the second embodiment, and therefore, description thereof will not be repeated.

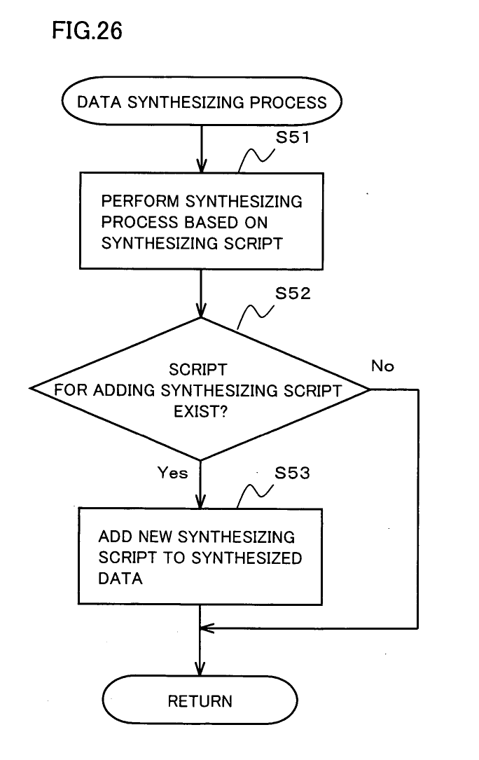

FIG. 26 is a flowchart representing a flow of a data synthesizing process executed by the contents synthesizing apparatus in accordance with the fifth embodiment. The data synthesizing process is the process executed in step S23 of the data synthesizing process described with reference to FIG. 15. Referring to FIG. 15, first, in step S51, by the synthesis processing portion, the synthesizing process is performed based on the synthesizing script. In step S52, the synthesis processing portion determines whether or not the synthesizing script includes any script indicating that a new synthesizing script should be included. If the synthesizing script includes a script indicating that a new synthesizing script should be included (Yes in step S52), in step S53, the synthesis processing portion adds the new synthesizing script included in the synthesizing script to the contents data synthesized in step S51, and the flow returns to the data synthesizing process described with reference to FIG. 15.

If the synthesizing script does not include any script indicating that a new synthesizing script should be included (No in step S52), the flow returns to the data synthesizing process described with reference to FIG. 15.

(First Example of Synthesis in Accordance with the Fifth Embodiment)

Here, an example of synthesis will be described, in which animation data is encrypted based on the synthesizing script included in contents data.

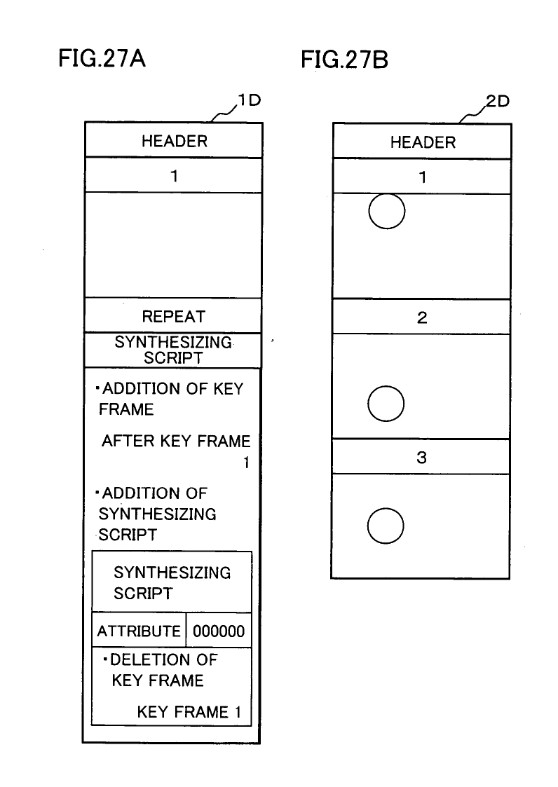

FIGS. 27A and 27B show data structures of the contents data before synthesis, in the first example of synthesis in accordance with the fifth embodiment. FIG. 27A represents data structure of contents data 1D including a synthesizing script. Referring to FIG. 27A, contents data 1D includes a header, a key frame 1 and the synthesizing script.

Key frame 1 includes a control data “repeat” that indicates repeated reproduction of key frames up to this key frame.

The synthesizing script of contents data 1D includes, as the first control contents, “addition of key frame”, and as the first parameter, “after key frame 1”. Further, it includes, as the second control contents, “addition of synthesizing script”, and as the second parameter, another synthesizing script.

The first control contents, “addition of key frame” has already been described with reference to FIG. 10, and therefore, description thereof will not be repeated. The first parameter “after key frame 1” indicates that the target position of the synthesizing process represented by the control contents is after the key frame of animation data included in contents data 1D including the synthesizing script.

The second control contents, “addition of synthesizing script” indicates that the target data designated by the parameter should be added to the contents data 1D. The said another script as the second parameter represents the target data of the synthesizing process represented by the control contents.

The said another synthesizing script as the second parameter includes a synthesizing script corresponding to attribute “000000”. The synthesizing script corresponding to attribute “000000” includes, as the control contents, “deletion of key frame”, and as a parameter, “key frame 1”. The control contents “deletion of key frame” indicates that the target key frame designated by the parameter should be deleted. The parameter “key frame 1” indicates that the target key frame of the synthesizing process represented by the control contents is key frame 1 of the animation data included in the contents data including the synthesizing script.

FIG. 27B shows data structure of contents data 2D. Referring to FIG. 27B, contents data 2D includes a header and key frames 1 to 3.

Key frames 1 to 3 are the same as key frames 2 to 4 of contents data 1B described with reference to FIG. 7A, and therefore, description thereof will not be repeated.

The contents synthesizing apparatus receives input of contents data 1D and 2D, and whether contents data 1D or 2D includes the synthesizing script or not is determined. As contents data 1D includes the synthesizing script, contents data 1D is synthesized with animation data 2D based on the synthesizing script, and a contents data 3D, which will be described later, is stored.

The synthesizing script describes that the key frame included in contents data 2D should be added after key frame 1 of contents data 1D including the synthesizing script, and another synthesizing script should be included in the synthesized contents data.

Therefore, the contents synthesizing apparatus provides key frame 1 of contents data 1D including the control data “repeat” as a new key frame 1.

Next, key frames 1 to 3 included in contents data 2D are added after key frame 1 of contents data 1D, to provide new key frames 2 to 4.

Finally, based on the new key frames 1 to 4, a header is generated, and contents data 3D including the header, new key frames 1 to 4, and the new synthesizing script included in the synthesizing script of contents data 1D is synthesized and stored.

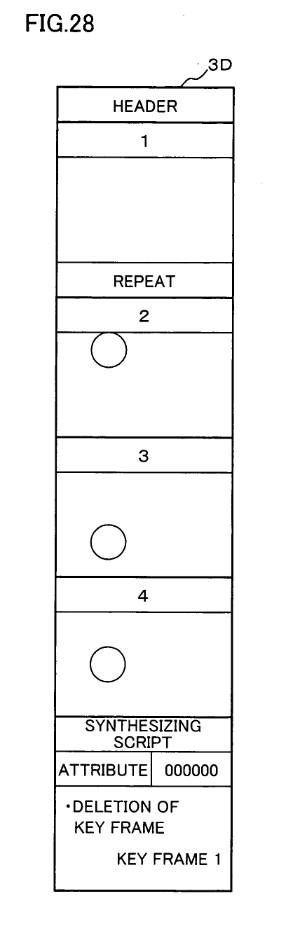

FIG. 28 shows data structure of the contents data 3D after synthesis, in the first example of synthesis in accordance with the fifth embodiment. Referring to FIG. 28, contents data 3D resulting from synthesis of contents data 1D and 2D by the contents synthesizing apparatus includes a header, key frames 1 to 4 and a synthesizing script.

Key frame 1 is the same as key frame 1 of contents data 1D described with reference to FIG. 27A.

Key frames 2 to 4 are the same as key frames 1 to 3 of contents data 2D described with reference to FIG. 27B.

The synthesizing script is the said another synthesizing script included in the synthesizing script of contents data 1D described with reference to FIG. 27A.

In this manner, the synthesizing process of adding the key frame included in contents data 2D to a prescribed portion of contents data 1D is controlled by the synthesizing script included in contents data 1D. As a result, the synthesizing process of adding other contents data 2D can be controlled from the side of contents data 1D.

As described above, by the synthesizing process represented by the first example of synthesis in accordance with the fifth embodiment, contents data 1D including the synthesizing script described with reference to FIG. 27A and contents data 2D described with reference to FIG. 27B are synthesized by the contents synthesizing apparatus, and contents data 3D described with reference to FIG. 28 is synthesized. Further, when contents data 2D is reproduced by a reproducing apparatus, an animation that a circular figure moves is reproduced. On the other hand, when contents data 3D is reproduced by a reproducing apparatus, though it includes a key frame to display an animation that the circular figure moves, the animation that the circular figure moves is not reproduced, as the control data “repeat” is included in key frame 1. In this manner, reproduction of contents data 2D can be prevented by the synthesis with contents data 1D. This state is referred to as an encrypted state of contents data 2D. Here, contents data 1D is a so called encryption key for encrypting contents data 2D.

Specifically, by using, as an encryption key, contents data including a key frame including the control data “repeat” and a synthesizing script describing that a new synthesizing script should be included in the synthesized contents data, the new script describing that a key frame included in another contents data should be added after the key frame including the control data “repeat” and that the key frame including the control data “repeat” corresponding to a prescribed attribute should be deleted, the said another contents data can be encrypted.

Further, the synthesizing script included in contents data 1G controls the synthesizing process of deleting a prescribed portion included in contents data 1G. As a result, the synthesizing process of deleting a prescribed portion of contents data 1G can be controlled from the side of contents data 1G.

(Second Example of Synthesis in Accordance with the Fifth Embodiment)

Here, a first example of synthesis will be described, in which encrypted animation data is decoded by the contents synthesizing apparatus.

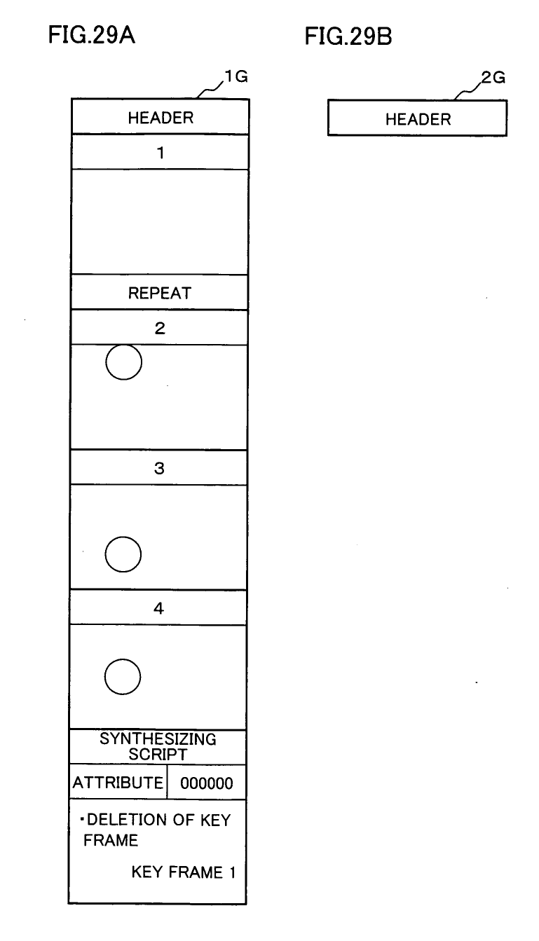

FIGS. 29A and 29B show data structures of the contents data before synthesis, in the second example of synthesis in accordance with the fifth embodiment. FIG. 29A shows the data structure of contents data 1G including a synthesizing script. Contents data 1G is the same as contents data 3D obtained by synthesis of contents data 2D with contents data 1D, described with reference to FIG. 28, and therefore, description will not be repeated.

FIG. 29B shows a data structure of contents data 2G. Referring to FIG. 29B, contents data 2G includes a header only. Specifically, the animation data included in contents data 2G has the attribute “000000”.

The contents synthesizing apparatus receives inputs of contents data 1G and 2G, and whether contents data 1G or 2G includes a synthesizing script or not is determined. As contents data 1G includes a synthesizing script, next, attribute of the animation data included in contents data 2G is determined. The attribute of animation data included in contents data 2G is “000000”, and therefore, based on the script corresponding to the attribute “000000”, contents data 1G is synthesized with contents data 2G, and contents data 3G, which will be described later, is stored.

The synthesizing script includes the script corresponding to the attribute “000000”. The script corresponding to the attribute “000000” describes that, when the animation data included in the other contents data 2G to be synthesized with contents data 1G including the synthesizing script is “000000”, key frame 1 of contents data 1G should be deleted.

Therefore, when contents data 1G and 2G are input, the contents synthesizing apparatus deletes key frame 1 of contents data 1G.

Next, key frames 2 to 4 of contents data 1G are provided as new key frames 1 to 3.

Finally, based on new key frames 1 to 3, a header is generated, and contents data 3G including the header and new key frames 1 to 3 is synthesized and stored.

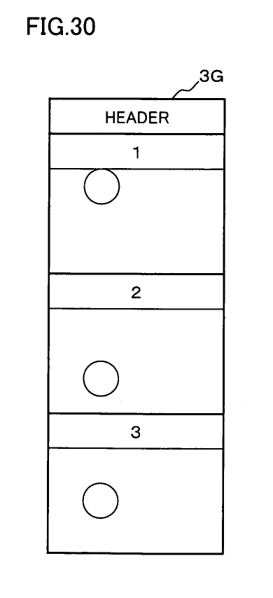

FIG. 30 shows data structure of the contents data 3G after synthesis, in the second example of synthesis in accordance with the fifth embodiment. Contents data 3G obtained by the synthesis of contents data 1G and 2G by contents synthesizing apparatus 100A shown in FIG. 30 is the same as contents data 2D described with reference to FIG. 27, and therefore, description thereof will not be repeated.

As described above, by the synthesizing process represented by the second example of synthesis in accordance with the fifth embodiment, contents data 1G same as the contents data 3D described with reference to FIG. 28 and including the synthesizing script described with reference to FIG. 29A is synthesized by the contents synthesizing apparatus with contents data 2G described with reference to FIG. 29B, whereby contents data 3G described with reference to FIG. 30 is synthesized. Contents data 3G is the same as contents data 2D described with reference to FIG. 27B. In this manner, when the contents data 1G having contents data 2D in an encrypted state is synthesized with contents data 2G, contents data 2D can be set to a reproducible state. This state is referred to the so-called decoded state of contents data 2D. Here, contents data 2G is a decoding key for decoding contents data 2D.

Specifically, by using a contents data of a prescribed attribute as a decoding key, another contents data can be decoded.

(Third Example of Synthesis in Accordance with the Fifth Embodiment)

Here, a second example of synthesis will be described, in which encrypted animation data is decoded by the contents synthesizing apparatus.

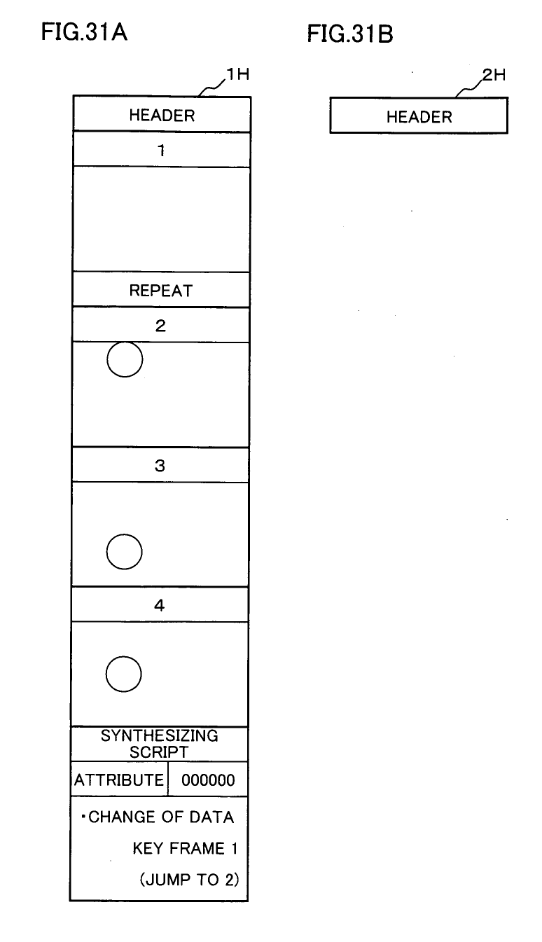

FIGS. 31A and 31B show data structures of the contents data before synthesis, in the third example of synthesis in accordance with the fifth embodiment. Referring to FIG. 31, contents data 1H has the synthesizing script included in contents data 3D described with reference to FIG. 28 changed. Specifically, it results from synthesis with contents data 2D, with another synthesizing script included in the synthesizing script of contents data 1D described with reference to FIG. 27 changed.

The synthesizing script included in contents data 1H includes a script corresponding to attribute “000000”. The synthesizing script corresponding to the attribute “000000” includes, as control contents, “change of data” and as a parameter, “key frame 1 (jump to 2)”. The control contents “change of data” indicates that the data at the target position designated by the parameter should be changed to the target data designated by the parameter. The parameter “key frame 1 (jump to 2)” indicates that the target position of the synthesizing process represented by the control contents is key frame 1 of animation data included in the contents data including the synthesizing script, and the target data of the synthesizing process represented by the control contents is the control data “jump to 2”.

FIG. 31B represents data structure of contents data 2H. Contents data 2H shown in FIG. 31B is the same as contents data 2G described with reference to FIG. 29B, and therefore, description thereof will not be repeated.

The contents synthesizing apparatus receives inputs of contents data 1H and 2H, and whether contents data 1H or 2H includes a synthesizing script or not is determined. As contents data 1H includes a synthesizing script, next, attribute of the animation data included in contents data 2H is determined. The attribute of animation data included in contents data 2H is “000000”, and therefore, based on the script corresponding to the attribute “000000”, contents data 1H is synthesized with contents data 2H, and contents data 3H, which will be described later, is stored.

The synthesizing script includes the script corresponding to the attribute “000000”. The script corresponding to the attribute “000000” describes that, when the animation data included in the other contents data 2H to be synthesized with contents data 1H including the synthesizing script is “000000”, the control data included in key frame 1 of the animation data of contents data 1H should be changed to control data “jump to 2”.

Therefore, when contents data 1H and 2H are input, the contents synthesizing apparatus changes the control data “repeat” included in key frame 1 of contents data 1H to control data “jump to 2”, to provide a new key frame 1.

Thereafter, key frames 2 to 4 of contents data 1H are provided as new key frames 2 to 4.

Finally, based on new key frames 1 to 4, a header is generated, and contents data 3H including the header and new key frames 1 to 4 is synthesized and stored.

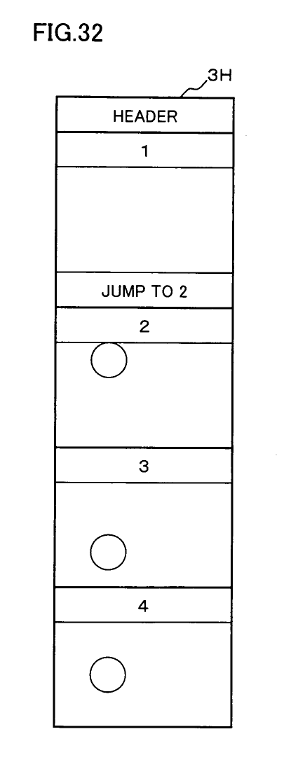

FIG. 32 shows data structure of the contents data 3H after synthesis, in the third example of synthesis in accordance with the fifth embodiment. Referring to FIG. 32, contents data 3H resulting from synthesis of contents data 1H and 2H by the contents synthesizing apparatus includes a header and key frames 1 to 4.

Key frame 1 corresponds to key frame 1 of contents data 1H with the control data changed to “jump to 2”.

Key frames 2 to 4 are the same as key frames 1 to 3 of contents data 1D described with reference to FIG. 27, and therefore, description thereof will not be repeated.

As described above, by the synthesizing process shown as a third example of synthesis in accordance with the fifth embodiment, contents data 1H including the synthesizing script described with reference to FIG. 31A having the synthesizing script of contents data 3D described with reference to FIG. 28 changed, and the contents data 2H described with reference to FIG. 31B are synthesized by the contents synthesizing apparatus, whereby contents data 3H described with reference to FIG. 32 is synthesized. The animation provided when the contents data 3G is reproduced by the reproducing apparatus is the same as that when contents data 2D described with reference to FIG. 27B is reproduced by the synthesizing apparatus. In this manner, when contents data 1H that corresponds to contents data 2D in the encrypted state is synthesized with contents data 2H, contents data 2D can be decoded.

Specifically, by using, as an encryption key, contents data including a key frame including the control data “repeat” and a synthesizing script describing that a new synthesizing script should be included in the synthesized contents data, the new script describing that a key frame included in the other contents data should be added after the key frame including the control data “repeat” and that the key frame including the control data “repeat” corresponding to a prescribed attribute should be changed to control data “jump to 2”, the other contents data can be encrypted. Further, by using a contents data including animation data of a prescribed attribute as a decoding key, another contents data can be decoded.

Though the process performed by contents synthesizing apparatus has been described in the fifth embodiment, the present invention can also be implemented as a method of synthesizing contents executing the process shown in FIG. 26 on a computer, a contents synthesizing program for causing a computer to execute the process shown in FIG. 26, a computer readable recording medium recording the contents synthesizing program, data structure of the contents data shown in FIGS. 27A, 29A and 31A, and a computer readable recording medium recording the contents data having the data structure.

### Sixth Embodiment

In the sixth embodiment, an example will be described, in which location information indicating location of the synthesizing script described with reference to the first embodiment is included in contents data 10.

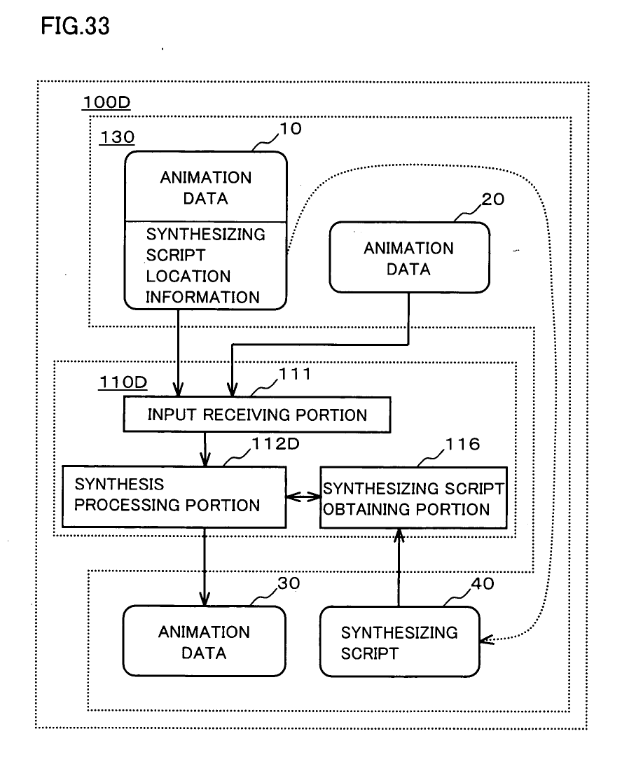

FIG. 33 schematically shows functions of the contents synthesizing apparatus 100D in accordance with a sixth embodiment. Referring to FIG. 33, control portion 110D of contents synthesizing apparatus 100D includes input receiving portion 111, a synthesis processing portion 112D, and a synthesizing script obtaining portion 116. Storage portion 130 of contents synthesizing apparatus 100D stores a plurality of contents data. The contents data includes contents data including animation data and a synthesizing script, and contents data including animation data. Input receiving portion 111 has already been described with reference to FIG. 2 of the first embodiment, and therefore, description will not be repeated.

When contents data input through input receiving portion 111 includes location information indicating location of the synthesizing script, synthesis processing portion 112D instructs synthesizing script obtaining portion 116 to obtain the synthesizing script.

In response to the instruction from synthesis processing portion 112D, synthesizing script obtaining portion 116 obtains a synthesizing script 40 and sends the same to synthesis processing portion 112D. In this example, synthesizing script 40 is stored in storage portion 130. The location indicated by location information of synthesizing script is not limited to a location indicated by the address in storage portion 130 of contents synthesizing apparatus 100D, and it may be a location indicated by a URL (Uniform Resource Locator), or a location indicated by a path of the synthesizing script included in recording medium 171.

Based on the synthesizing script obtained by synthesizing script obtaining portion 116, synthesis processing portion 112D synthesizes contents data 10 input through input receiving portion 111 with contents data 20 input through input receiving portion 111. Synthesis processing portion 112D has synthesized contents data 30 stored in storage portion 130. Synthesis processing portion 112D may directly transmit the synthesized contents data 30 to other PC or the like through network 500 using communication portion 160, or store the same on recording medium 171 using external storage apparatus 170.

When the synthesizing script of contents data 1D described with reference to FIG. 27 includes location information of the synthesizing script to be included in newly synthesized contents data, synthesis processing portion 112D may have the synthesizing script obtained by synthesizing script obtaining portion 116 included in the newly synthesized contents data, based on the location information.

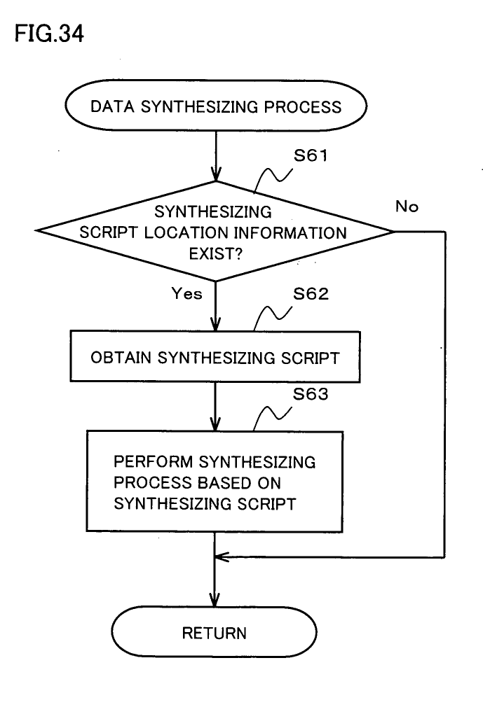

FIG. 34 is a flowchart representing a flow of a data synthesizing process executed by the contents synthesizing apparatus 100D in accordance with the sixth embodiment. The data synthesizing process is executed in step S13 of the contents synthesizing process described with reference to FIG. 3. Referring to FIG. 34, first, in step S61, synthesis processing portion 112D interprets the synthesizing script included in contents data 10 input in step S111, and in step S62, whether contents data 10 includes location information of synthesizing script or not is determined. If contents data 10 includes the location information of synthesizing script (Yes in step S62), in step S63, synthesizing script obtaining portion 116 obtains the synthesizing script indicated by the location information of synthesizing script, and in step S64, based on the synthesizing script obtained in step S63, synthesis processing portion 112D performs the synthesizing process of synthesizing contents data 10 input in step S11 with contents data 20 input in step S11, and the flow returns to the contents synthesizing process.

If contents data 10 does not include the location information of synthesizing script (No in step S62), the flow returns to the contents synthesizing process.

As described above, in contents synthesizing apparatus 100D in accordance with the sixth embodiment, input of the first contents data including the location information indicating location of the synthesizing script describing synthesis of contents data and input of the second contents data are received, the synthesizing script indicated by the location information included in the input first contents data is obtained, and based on the obtained synthesizing script, the input first contents data is synthesized with the input second contents data. Therefore, the synthesizing process is controlled by the synthesizing script indicated by the location information included in the first contents data. Further, as the location information of synthesizing script is included in the first contents data, it is unnecessary to newly prepare the synthesizing script when the first and second contents data are synthesized. As a result, the synthesizing process can be controlled from the side of the contents data and the necessity of newly preparing the synthesizing script required for synthesizing contents data can be eliminated.

Further, in contents synthesizing apparatus 100D in accordance with the sixth embodiment, another synthesizing script indicated by the location information included in the synthesizing script indicating location of the said another synthesizing script is obtained, and the obtained another synthesizing script is included in the synthesized contents data. As a result, the synthesizing process can be controlled from the side of the newly synthesized contents data.

Though the process performed by contents synthesizing apparatus 100D has been described in the sixth embodiment, the present invention can also be implemented as a method of synthesizing contents executing the process shown in FIG. 34 on a computer, a contents synthesizing program for causing a computer to execute the process shown in FIG. 34, and a computer readable recording medium recording the contents synthesizing program.

Although the present invention has been described and illustrated in detail, it is clearly understood that the same is by way of illustration and example only and is not to be taken by way of limitation, the spirit and scope of the present invention being limited only by the terms of the appended claims.

1. (canceled)

2. A contents synthesizing apparatus, comprising:
an input receiving portion receiving an input of first contents data including a synthesizing script describing synthesis of contents data and an input of second contents data;
a synthesis processing portion synthesizing said input first contents data with said input second contents data, based on the synthesizing script included in said input first contents data; and
an attribute determining portion determining an attribute of said second contents data; wherein
said synthesizing script includes scripts corresponding to a plurality of attributes of the contents data respectively; and
said synthesis processing portion synthesizes said input first contents data with said input second contents data, based on the script corresponding to said determined attribute.

3. A contents synthesizing apparatus, comprising:
an input receiving portion receiving an input of first contents data including a synthesizing script describing synthesis of contents data and an input of second contents data;
a synthesis processing portion synthesizing said input first contents data with said input second contents data, based on the synthesizing script included in said input first contents data; and
a time obtaining portion for obtaining current time; wherein
said synthesizing script includes scripts corresponding to time of synthesis by said synthesis processing portion; and
said synthesis processing portion synthesizes said input first contents data with said input second contents data, based on the script corresponding to the obtained current time.

4. A contents synthesizing apparatus, comprising:
an input receiving portion receiving an input of first contents data including a synthesizing script describing synthesis of contents data and an input of second contents data;
a synthesis processing portion synthesizing said input first contents data with said input second contents data, based on the synthesizing script included in said input first contents data; and
a position obtaining portion obtaining a current position of said contents synthesizing apparatus; wherein
said synthesizing script includes scripts corresponding to positions; and
said synthesis processing portion synthesizes said input first contents data with said input second contents data, based on the script corresponding to the obtained current position.

5. A contents synthesizing apparatus, comprising:
an input receiving portion receiving an input of first contents data including a synthesizing script describing synthesis of contents data and an input of second contents data; and
a synthesis processing portion synthesizing said input first contents data with said input second contents data, based on the synthesizing script included in said input first contents data; wherein
said synthesizing script includes another synthesizing script;
said apparatus further comprising
adding portion adding said another synthesizing script to said synthesized contents data.

6. A contents synthesizing apparatus, comprising:
an input receiving portion receiving an input of first contents data including a synthesizing script describing synthesis of contents data and an input of second contents data; and
a synthesis processing portion synthesizing said input first contents data with said input second contents data, based on the synthesizing script included in said input first contents data; wherein
said synthesizing script includes location information indicating location of another synthesizing script;
said apparatus further comprising:
an obtaining portion obtaining another synthesizing script indicated by said location information; and
an adding portion adding said obtained another synthesizing script to said synthesized contents data.

7. (canceled)

8. (canceled)

9. A contents synthesizing apparatus, comprising:
an input receiving portion receiving an input of first contents data including a synthesizing script describing synthesis of contents data and an input of second contents data; and
a synthesis processing portion synthesizing said input first contents data with said input second contents data, based on the synthesizing script included in said input first contents data; wherein
said first contents data includes a key frame defining a frame of animation data;
said second contents data is data that can be included in said key frame; and
said synthesizing script includes a script describing that prescribed data included in the key frame of said first contents data should be changed to said second contents data.

10. A contents synthesizing apparatus, comprising:
an input receiving portion receiving an input of first contents data including a synthesizing script describing synthesis of contents data and an input of second contents data; and
a synthesis processing portion synthesizing said input first contents data with said input second contents data, based on the synthesizing script included in said input first contents data; wherein
said synthesizing script includes a script describing that a prescribed portion of said first contents data should be deleted.

11. A contents synthesizing apparatus, comprising:
an input receiving portion receiving an input of first contents data including location information indicating location of a synthesizing script describing synthesis of contents data and an input of second contents data;
obtaining portion obtaining a synthesizing script indicated by the location information included in said input first contents data; and
a synthesis processing portion synthesizing said input first contents data with said input second contents data, based on said obtained synthesizing script.

12. The contents synthesizing apparatus according to claim 11, wherein
said synthesizing script includes location information indicating location of another synthesizing script; and
said obtaining portion further obtains another synthesizing script indicated by said location information;
said apparatus further comprising
an adding portion adding said obtained another synthesizing script to said synthesized contents data.

13. (canceled)

14. A contents synthesizing method of synthesizing contents by a computer, comprising the steps of:
receiving an input of first contents data including location information indicating location of a synthesizing script and an input of second contents data;
obtaining the synthesizing script indicated by the location information included in said input first contents data; and
synthesizing said input first contents data with said input second contents data, based on said obtained synthesizing script.

15. (canceled)

16. A contents synthesizing program, causing a computer to execute the steps of:
receiving an input of first contents data including location information indicating location of a synthesizing script and an input of second contents data;
obtaining the synthesizing script indicated by the location information included in said input first contents data; and
synthesizing said input first contents data with said input second contents data, based on said obtained synthesizing script.

17. (canceled)

18. A computer readable recording medium recording a contents synthesizing program, causing a computer to execute the steps of:
receiving an input of first contents data including location information indicating location of a synthesizing script and an input of second contents data;
obtaining the synthesizing script indicated by the location information included in said input first contents data (S62); and
synthesizing said input first contents data with said input second contents data, based on said obtained synthesizing script (S63).

19. A data structure of contents data, comprising
contents data, and a synthesizing script used when a synthesizing process of synthesizing said contents data with another contents data is executed by a computer.

20. The data structure of contents data according to claim 19, wherein
said contents data and said another contents data include key frames defining frames of animation data; and
said synthesizing script includes a script describing that a key frame included in said another contents data should be added to a prescribed portion of said contents data.

21. The data structure of contents data according to claim 19, wherein
said contents data includes a key frame defining a frame of animation data;
said another contents data is data that can be included in said key frame; and
said synthesizing script includes a script describing that prescribed data included in the key frame of said contents data should be changed to said another contents data.

22. The data structure of contents data according to claim 19, wherein
said synthesizing script includes a script describing that a prescribed portion of said contents data should be deleted.

23. A computer readable recording medium recording contents data of a data structure including contents data, and a synthesizing script used when a synthesizing process of synthesizing said contents data with another contents data is executed by a computer.

24. A computer readable recording medium recording contents data having the data structure according to claim 23, wherein
said contents data and said another contents data include key frames defining frames of animation data; and
said synthesizing script includes a script describing that a key frame included in said another contents data should be added to a prescribed portion of said contents data.

25. A computer readable recording medium recording contents data having the data structure according to claim 23, wherein
said contents data includes a key frame defining a frame of animation data;
said another contents data is data that can be included in said key frame; and
said synthesizing script includes a script describing that prescribed data included in the key frame of said contents data should be changed to said another contents data.

26. A computer readable recording medium recording contents data having the data structure according to claim 23, wherein
said synthesizing script includes a script describing that a prescribed portion of said contents data should be deleted.
